(19) United States
(12) Patent Application Publication
(10) Pub. No.: US 2016/0357493 A1
(43) Pub. Date: Dec. 8, 2016

(54) SYNCHRONIZATION OF VIDEOS IN A DISPLAY WALL

(71) Applicant: BARCO CONTROL ROOMS GMBH, Karlsruhe (DE)

(72) Inventor: Udo ZERWAS, Ettlingen (DE)

(73) Assignee: Barco Control Rooms GmbH, Karlsruhe (DE)

(21) Appl. No.: 15/033,811

(22) PCT Filed: Oct. 30, 2013
(86) PCT No.: PCT/EP2013/003268

§ 371 Date: Aug. 10, 2016

(51) Int. Cl. G06F 3/14; G09G 5/12

(52) U.S. Cl. CPC G06F 3/1446; G06F 3/1438; G09G 5/12; G09G 2300/026; G09G 2360/06

(57) ABSTRACT

A method and a device for synchronizing the display of video frames from a video stream of a video insertion of a video image source, which is simultaneously presented on two or more displays of a display wall. The synchronous, tearing free display is realized by means of a video frame queue for the video frames, a mediation function which is commonly used by the network graphics processors involved in the display of the video insertion and which, during a mediation period that extends over a plurality of vertical retraces of the display wall, determines which video frame is displayed by the displays and establishes a balance between the vertical display frequency and the video stream frequency, and synchronization messages which are sent before the start of a mediation period by a master network graphics processor of a display to the slave network graphics processors of the other displays.

The invention relates to the synchronization of video and video frames from video streams, which are displayed on two or more displays of a display wall composed of a plurality of screens. Another common name for a display is screen or monitor. A display wall, which is also referred to as a video wall, includes a plurality of displays (D1, D2, . . . , Dn), for example in projection modules or TFT, LED, OLED or LCD screens. Projection modules include a projection screen for displaying an image generated by an encoder on a reduced scale, which is projected in an enlarged manner by means of a projection device on the projection screen. A distinction is made between rear projection and incident light devices. Active displays like TFT, LED, OLED or LCD screens create the image themselves true to original scale without a projection device.

Large displays are widely used in cases where a large, complex image, for example, consisting of various video or computer frames, is to be displayed in large format. Large images are generally understood to be images with screen diagonals of more than 0.5 m that can be up to several meters long. Common areas of application for such large displays are presentations of images which are viewed by several people at once, for example at conferences and presentations.

If the displayed image is to exceed a certain size and complexity with the given quality requirements, this is no longer possible with a single display. In such cases, the image is composed of partial images, each presented by a display. The image presented by each display is in this case a partial image of a complete image presented together by all displays of a display wall or projection screen that spans multiple displays. A common display wall thus comprises several checkered, tiled and juxtaposed displays, and a display wall rack which supports the displays. Each individual display of a display wall presents a display detail of an image to be presented with the display wall. So that the impression of the whole image is not disturbed, the individual displays must be adjacent to one another essentially without any gap. Even a distance of one millimeter is clearly recognizable by a viewer as a tile structure and is perceived as disturbing. This raises the problem of assembling the partial images presented by the individual displays into a large screen in such a way, that a checkerboard-like-image impression of the overall image is avoided. This relates to, on the one hand, the decrease in intensity of a partial image from the center to its edge. On the other hand, it is best to avoid a broad, clearly visible web between the partial images.

According to the prior art, it is possible to place and/or stack a large number of displays in a modular construction of a large-scale display wall in order to display on the display wall a large image composite of the many partial images of the individual displays. The number of displays which are assembled to form a display wall is up to 150 or more. Large-scale display walls which are composed, for example, of twelve or more displays, have a display wall diagonal of several meters. Such display walls are common, for example, in modern control room display technology.

The number of video image sources displayed on the display wall at the same time is, in some cases, only one, for example, if only one video is to be displayed on a large display wall. However, there are also many applications, e.g. in the control room display technology or in monitoring devices, in which numerous video image sources are displayed on a display wall at the same time. The display wall thus presents not only one video but rather many video image sources.

In a display wall, however, it is not only the problem of a preferably web-free arrangement of the displays. The images shown on the displays must also be synchronized for moving objects simultaneously displayed on a plurality of adjacent displays, in such a manner that the image composed of the participating displays shows the viewer a synchronous image on the display wall. Due to the technical conditions, particularly transit time differences, an optical “tearing effect”, described in more detail in the figure description below, can occur, whereat at a particular moment of time, video frames of a video image source associated with a particular moment of time can be displayed on the displays of a display wall at different times. This optical effect is particularly disturbing in horizontally or vertically moving objects, namely on the edges of the displays showing the moving object, because with a lack of synchronization during transition from one display to another at this location, the object appears to be “torn apart”.

The prior art provides the following two approaches to solving this problem.

Sungwon Nam, Sachin Deshpande, Venkatram Vishwanath, Byungil Jeong, Luc Renambot, Jason Leigh, “Multiapplication, Intertile Synchronization on Ultra-High-Resolution Display Walls”, Proceedings of the first annual ACM SIGMM conference on multimedia systems, 2010 Proceeding, p. 145-156, describes a method of synchronization between the units or displays of a display wall for displaying a variety of applications with ultra-high resolution. However, unlike video streams, generic applications have no inherent frequency. In this publication, the displays are controlled by a cluster of computers and each computer can control one or more displays. The many applications shown on the displays can thereby have varying frame rates, independent of each other. The frame lock or gen lock is realized with a hardware solution to synchronize the vertical synchronization of the graphics processors. The content buffer and swap buffer synchronization is effected by a single global synchronization master. The refresh rate (vertical display frequency) of the displays must be greater than the maximum frame rates of all applications presented. The content buffer and swap buffer synchronization requires intensive communication between the global synchronization master and display nodes. To display one frame, (m+1)n synchronization messages must be transmitted over the network in case of the single-phase algorithm and (m+3)n synchronization messages in case of the two-phase algorithm described in this publication, whereat m is the number of video image sources and n is the number of displays in the display wall. This leads to a high network load and reduces the scalability of the system.

In Giseok Choe, Jeongsoo Yu, Jeonghoon Choi, Jongho Nang, “Design and Implementation of a Real-time Video Player on Tiled Display System”, Seventh International Conference on Computer and Information Technology (CIT 2007), IEEE Computer Society, 2007, p. 621-626, a real-time video player on a tiled display system is described that includes a plurality of PCs to form a large display wall with high resolution. In the system proposed there, a master process transmits a compressed video stream via UDP multicast to a plurality of PCs. All PCs receive the same video stream, decompress it, cut their desired details out of the decompressed video frame and present it on their displays while they are synchronized among one another by a synchronization process. By means of synchronization of the hardware clocks of the PCs, skew is avoided between the displays of the display wall. By means of flow control based on the bit rate of the video stream and pre-buffering, jitter is avoided. However, the system requires the availability of accurate timestamps in the video frames and is suitable only for displaying a single video image source, but not for displaying multiple video image sources simultaneously on the display wall.

The solutions known according to the prior art are therefore disadvantageous, in particular with regard to the necessary hardware outlay, the high network load and the lack of general applicability for displaying a variety of arbitrary video image sources on the display wall at the same time.

Based on the prior art, the present invention seeks to provide an improved method and apparatus with which the images from any video image source that are simultaneously displayed on a plurality of (particularly, neighboring) displays of a display wall can be synchronized in such a way, that the image composed for the viewer with the displays involved provides a synchronous image on the display wall.

As compared to conventional synchronization methods, the frequency, or frequency of synchronization messages, which are transmitted via the network to synchronize the presentation on the displays, are reduced in order to only slightly burden the network.

In accordance with the invention, this object is achieved by a method with the features of the appended claim 1. Preferred embodiments, and further embodiments and uses of the invention will become apparent from the independent and dependent claims and the following description with the accompanying drawings.

A computer-implemented method according to the invention for synchronizing the display of video frames from a video stream with a video stream frequency fₛ of a video insertion of a video image source, which is simultaneously displayed on two or more displays of a display wall composed of a plurality of displays, wherein

the displays are each controlled by an associated network graphics processor which includes a computer with a network card and a graphics card, and are operated with the same vertical display frequency f_{d},
the local clocks are synchronized on the network graphics processors, preferably by PTP (Precision Time Protocol),
the vertical retraces of the graphics cards of the network graphics processors that drive the displays are synchronized by means of frame lock or gen lock, and
the video stream is transmitted from the video image source over a network to the network graphics processors, wherein preferably the video image source is respectively encoded and compressed by means of an encoder prior to transmission over the network, and after receipt is decoded by the network graphics processors by means of a decoder,
and is characterized by the fact that it comprises the following steps:

The network graphics processors participating in the display of a video image source are organized in a master-slave architecture, wherein one network graphics processor is configured as a master network graphics processor for the video image source, and the other network graphics processors are configured as slave network graphics processors, wherein for each video image source the respective allocation of roles is arranged such that for synchronizing the display of the video image source, the master network graphics processor sends synchronization messages to the slave network graphics processors, which are received and evaluated by the slave network graphics processors,

the video frames are each identified by means of an absolute frame identification number that is embedded in the video stream, which absolute frame identification number is preferably derived from the RTP timestamps of the video frames,
the display of the video frames is synchronized among the network graphics processors at frame synchronization points of time, which are each followed by a mediation period, which extends over a plurality of vertical retraces of the display wall and lasts until the next frame synchronization point of time, wherein shortly before a frame synchronization point of time, i.e. before the start of a mediation period, a synchronization message is sent from the master network graphics processor to the slave network graphics processors at a synchronization message point of time, and wherein during the mediation period, video frames are displayed synchronously by the network graphics processors in that the network graphics processors each locally determine the video frames to be displayed by means of a mediation function, which is common to the network graphics processors, and wherein parameters which are included in the argument of the mediation function and are required for synchronously displaying the video frames, are transmitted in the synchronization message,
wherein these parameters either include the video stream frequency fₛ, measured by the master network graphics processor, or the equivalent period Tₛ of the video stream frequency fₛ measured by the master network graphics processor and the vertical display frequency f_{d} measured by the master network graphics processor, or the equivalent period T_{d} of the vertical display frequency f_{d} measured by the master network graphics processor, or said parameters include the ratio fₛ/f_{d} of the video stream frequency fₛ measured by the master network graphics processor with the vertical display frequency f_{d} measured by the master network graphics processor, or its equivalent reciprocal value f_{d}/fₛ, or these parameters include the ratio T_{d}/Tₛ of the period T_{d} of the vertical display frequency f_{d} measured by the master network graphics processor with the period Tₛ of the video stream frequency fₛ measured by the master network graphics processor, or its equivalent reciprocal value Tₛ/T_{d},
the master network graphics processor synchronizes the mediation function by sending synchronization messages at a rate that is lower than the vertical display frequency f_{d},
the video frames of the video stream that are to be rendered are each counted locally by the network graphics processors by means of local video frame counters, and are each buffered by hooking into a respective video frame queue, including their associated absolute frame identification number and the associated local video frame counter, so that each video frame queue contains the local mapping between the absolute frame identification numbers and the local video frame counter,
with the synchronization message of the master network graphics processor to the slave network graphics processors, a momentary view of the video frame queue of the master network graphics processor is transmitted at the synchronization message point of time, which is by an up-front to the frame synchronization point of time before the next frame synchronization point of time, whereby the momentary view contains the local mapping between the absolute frame identification numbers and the local video frame counter of the master network graphics processor for the video frames in the video frame queue of the master network graphics processor,
in order to detect a local frame offset that specifies the number of video frames by which the display of the video frames on the respective slave network graphics processor is offset relative to the display of the video frames on the master network graphics processor prior to the synchronization message, the momentary view of the video frame queue of the master network graphics processor, which is received with the synchronization message by the slave network graphics processors, is locally compared to a locally stored momentary view of the video frame queue of the slave network graphics processor, and from this comparison, the frame offset is determined,
and the local frame offset is corrected on the slave network graphics processors starting with the frame synchronization point of time, in that starting with the frame synchronization point of time on the slave network graphics processors, the frame offset is added to the local video frame counter of the slave network graphics processor, which specifies which video frame is to be rendered,
so that the slave network graphics processors receive from the master network graphics processor everything that they require to synchronize in the synchronization message, in order to be able to autonomously display the video frames of the video insertion locally in a synchronized manner with the master network graphics processor, both at the frame synchronization point of time as well as during the subsequent mediation period up to the subsequent frame synchronization point of time.

The invention is further directed to a computer program product, in particular a computer-readable, digital data carrier with stored, computer-readable, computer-executable instructions for performing a method according to the invention, i.e. with instructions that when loaded into a processor, a computer or computer network and executed, cause the processor, computer or computer network to carry out process steps and operations in accordance with the method according to the invention.

The invention is further directed to a computer system comprising a plurality of network graphics processors, each of which has a computer with a network card, a graphics card and a network interface, and a video synchronization module for performing a method according to the invention. The video synchronization module can be implemented as hardware or preferably fully implemented as software.

Ultimately, the invention is directed to a display wall, which is composed of a plurality of displays and is used for displaying one or more video streams from one or more video image sources, and which comprises a computer system according to the invention.

The invention is based on the realization that with the synchronization of video frames according to the invention, which is substantially based on the combined use of a respective video frame queue for the video frames in the network graphics processors, and a mediation function commonly used in the network graphics processors and which is synchronized from a master network graphics processor with a comparably low rate, it is possible to synchronize the display of the video frames of a video image source or a video insertion on several screens of a display wall with regard to frequency and phase in such a way, that a tearing free display is achieved, wherein the network is only slightly loaded with the synchronization process and synchronization messages. The invention allows for the compensation of differences between the frequency of video streams displayed and the vertical display frequency, as well as differences in the transfer durations of the video frames of a displayed video stream via the network to the individual network graphics processors, as well as differences in the processing times of the video frames in the individual network graphics processors. Here, primarily, but not exclusively, the compensation of the different frequencies is based on the use of the mediation function, and the compensation of the different transmission and processing times (so-called de-jittering) is based on the use of the video frame queues. The use of a mediation function according to the invention leads to a considerable reduction in the frequency of the synchronization messages. The invention thus advantageously enables a tearing free display combined at the same time with a low load on the network.

In contrast to the abovementioned reference, Sungwon Nam et al., the present invention has the following advantages:
(i) The refresh rate (vertical display frequency) of the displays is independent of the frame rate (video stream frequency) of the individual video image sources, therefore, a plurality of video image sources of any arbitrary video stream frequency can be presented.
(ii) The role of the master is linked to a particular video image source. Therefore, various network graphics processors can act as a master for the content synchronization of different video image sources. This is an advantage in the implementation of the invention in comparison to a system in which a single master is required for synchronization.
(iii) Between two, consecutive frame synchronization points of time, a mediation function determines which video frames are displayed sequentially. However, the frequency with which the frame synchronizations are performed, i.e. the frequency of the frame resynchronization (recorrelation of the synchronous display of video frames) is much lower than the vertical display frequency (synchronization repetition frequency of the displays, display vertical retrace refresh rate). This considerably reduces the additional load on the network due caused by synchronization operations that have to be run across the network in order to avoid tearing. It is all the more advantageous, the more video image sources or video insertions, e.g. 40 to 60, need to be synchronized.
(iv) The synchronization processes run independently for each video image source. When executing a synchronization of multiple video streams (video insertions IS) on more than one network graphics processor NGP in a parallel manner, the synchronization processes for several simultaneously synchronized video streams (video insertions IS) have no influence on one another, i.e. they operate completely independent of each other, at least when no transparent superimpositions of video insertions are needed, which in practice is almost always the case. The method of content synchronization according to the invention thus is a separate process running separately and independently from one another for each video stream shown on the display wall, without the individual synchronization processes for the respective video streams (video insertions IS) requiring coordination or synchronization with each other.
(v) The synchronization of the vertical retraces of the graphics cards output signals is effected without additional hardware by using software to program the pixel clock on each graphics card. Since the video frames are rendered into an invisible second buffer (double buffering) and are only become visible when this hidden buffer is copied during the next vertical retrace to the visible range (swap-locking), the redrawing of video frames for any number of video image sources is automatically synchronized between all network graphics processors.
In comparison to the abovementioned reference Giseok Choe et al., the invention particularly has the following advantages:
(i) The invention can handle a variety of video image sources with differing frame rates. The frame rates of the video image sources can also be different from the refresh rate (vertical display frequency) of the displays of the display wall placed in a tiled manner.
(ii) The timestamps embedded in the video stream are only used in the invention to identify the video frames; the time information of the timestamps is not used for synchronizing the video frames. This is advantageous because not all encoders support correct time stamp information. In contrast, in the reference Giseok Choe et al., the solution for a synchronous display of video frames completely depends on the availability of correct timestamps for the video frames.

The synchronized presentation of new video frames on the network graphics processors (NGP 1, NGP 2, . . . , NGP n) is not yet a content synchronization, i.e. the synchronized appearance of a new video frame does not guarantee that the frame in question is also the same video frame from the video stream. The processes that ultimately accomplish this content synchronization work separately and independently for each video image source, wherein for each of these processes a network graphics processor is the master and all others are the slaves. Different presentations of video image sources can have different network graphics processors as a master. The role of the master is to send the synchronization messages for the video frame content synchronization to all participating slaves.

The main advantage of the mediation function according to the invention is therefore that since a synchronization message does not need to be sent over the network for each individual video frame of a video stream but instead only at the time intervals of the frame synchronization points of time TS, the network load required for synchronization is greatly reduced. The time between two frame synchronizations, i.e. the mediation period TM between two frame synchronization points of time TS, for this invention is typically one second instead of 20 msec, as would normally be required for a frame-by-frame synchronization with a video stream frame rate of 50 Hz. Especially advantageous is the fact that for the frame synchronization according to the invention, it is not necessary to send synchronization messages from the slave network graphics processors to the master network graphics processor, but that the transmission of synchronization messages from the master network graphics processor to the slave network graphics processors is sufficient. The additional data processing workload on the network graphics processors necessary for locally comparing the information from the synchronization message with locally stored information, and for calculating the mediation function or respectively determining the video frame to be rendered, is very low and represents virtually no appreciable burden considering the high computing power of conventional network graphics processors.

The implementation of the synchronization according to the invention consists of mediation and frame synchronization and is effected preferably entirely in software (e.g. on a LINUX operating system) on the standard hardware component that does the rendering (and also the software or hardware decoding, if applicable). Such a standard hardware component in the form of a network graphics processor comprises a computer with network card, graphics card and (Ethernet) network interface. The invention thus has the advantage that it can be implemented without additional hardware components in a conventional display wall with the existing, standard hardware.

In advantageous, practical embodiments, the method according to the invention can comprise in particular one or more of the following, further steps:

The vertical retraces of the graphics cards of the network graphics processors are counted locally by the network graphics processors by means of a Vsync counter that is synchronized among the network graphics processors,

by the network graphics processors, local relative Vsync counters NSR are formed which represent the difference between the current, synchronized Vsync counter and its value at the last frame synchronization point of time,
the network graphics processors use the relative Vsync counters NSR as the argument value of the mediation function MF, wherein the following applies for the mediation function MF

$$NFR = MF ( NSR ) = mediation ( NSR ) = floor ( NSR \frac{{f}_{s}}{{f}_{d}} ) = floor ( NSR \frac{{T}_{d}}{{T}_{s}} )$$

and the mediation function MF calculates a local relative video frame counter NFR as a function value, which is the difference between the local video frame counter of the video frame to be selected from the video frame queue for rendering, and the local video frame counter of the video frame at the last frame synchronization point of time, so that the video frame to be rendered for display on the display by the respective network graphics processor is determined and selected for rendering by the network graphics processors by use of the local relative video frame counter NFR,
wherein due to the ratio of the video stream frequency fₛ divided by the vertical display frequency f_{d} (or the reciprocal ratio of the period durations) that is contained in the argument value of the mediation function MF, the mediation function MF balances and mediates between these two frequencies during the processing of the video frames, if these frequencies are different.

In advantageous embodiments, the method according to the invention may further comprise one or a plurality of the following, additional process steps:

In order to determine the frame offset, the absolute frame identification numbers contained in the momentary views are used in the comparison of the momentary view of the video frame queue of the master network graphics processor received with the synchronization message with a locally stored momentary view of the video frame queue of the slave network processor, to check whether a common reference video frame is contained in the two momentary views, and for this reference video frame by the local allocation between the absolute frame identification numbers and the local video frame counters that is contained in the momentary views, a video frame counter difference is formed, which is the difference between the local video frame counter of the slave network graphics processor of the reference video frame, and the local video frame counter of the master network graphics processor of the reference video frame,

and by means of the video frame counter difference, the frame offset is determined in that first, the slave network graphics processor forms a conversion difference for the reference video frame, which is the difference between its local video frame counter and the video frame counter difference,
and by subtracting the conversion difference from the local video frame counter of the slave network graphics processor, the slave network graphics processor calculates the local video frame counter of the master network graphics processor for the video frame which was selected by the master for rendering at the synchronization message point of time,
and the frame offset is calculated as the difference between the local video frame counter of the master network graphics processor for the video frame that was selected for rendering by the slave network graphics processor at the synchronization message point of time, and the local video frame counter of the master network graphics processor for the video frame that was selected for rendering by the master network graphics processor at the same synchronization message point of time.

The question behind this process is how the slave network graphics processor uses the momentary view received by the synchronization message to determine the local video frame counter of a video frame which the same video frame has on the master network graphics processor. The slave network graphics processor thereby scales its local video frame counter to the master network graphics processor. This is done by using the video frame counter difference that is constant and independent of the video frame as long as no video frame is lost from the video stream during decoding of a video stream on a network graphics processor, e.g. due to a malfunction, a failure, a faulty transmission or a timing issue. The video frame counter difference of the local video frame counters is needed to convert the local video frame counter of the slave network graphics processor to the master network graphics processor when determining and correcting the frame offset between the slave network graphics processor and the master network graphics processor. The slave network graphics processor can calculate the local video frame counter on the master network graphics processor for any given video frame by subtracting the conversion difference from its local video frame counter.

In order to determine the frame offset, when comparing the momentary views, one can generally look for any absolute frame identification number included in both momentary views, i.e. in the momentary view of the master network graphics processor which was transmitted with the synchronization message to the slave network graphics processor and in the momentary view of the video frame queue of the slave network graphics processor Slave-NGP, to determine the frame offset using this common reference video frame. In a preferred embodiment with which in an optimized manner one can check whether the intervals of the included, absolute frame identification numbers overlap in the two momentary views, and a common reference video frame is determined, preferably tests with method steps in accordance with one or both of the following alternatives are carried out.

The first alternative is that when comparing the momentary views in order to determine the video frame counter difference, one checks whether the video frame which was put last to the video frame queue of the slave network graphics processor by the slave network graphics processor, i.e. immediately prior to the sending of the synchronization message, is included in the momentary view of the master network graphics processor. If so, this video frame can be used as a common reference video frame.

The second alternative is that for determining the video frame counter difference, the value of the local video frame counter of the master network graphics processor for the video frame put last to the video frame queue of the master network graphics processor by the network graphics processor, i.e. immediately prior to sending the synchronization message, and the absolute frame identification number of this video frame are transmitted with the synchronization message of the master network graphics processor to the slave network graphics processors, and that when comparing the momentary views one checks whether this video frame is included in both momentary views that are compared. If so, this video frame can be used as a common reference video frame.

In this embodiment, the frame offset is determined in that the slave network graphics processor calculates the difference between the local video frame counter (with the video frame counter difference converted to the master) of the video frame selected for rendering at the last frame synchronization point of time, and the local video frame counter of the corresponding video frame of the master network graphics processor (transmitted with the last synchronization message by the master network graphics processor), and with this difference, corrects the local relative video frame counter of the slave network graphics processor by adding or subtracting.

These two tests can be performed in any order and when one of the two tests is successful, i.e. an overlap is detected, the other test no longer needs be performed. If in contrast, both tests are not successful, there is no common reference video frame in the compared momentary views.

As follows, the invention is explained in more detail with the illustrated examples. The special features described therein can be used individually or in combination to create preferred embodiments of the invention. Identical or identically acting parts are labeled in the various figures with the same reference signs, and are usually described only once even if they can be advantageously used in other embodiments. The drawings:

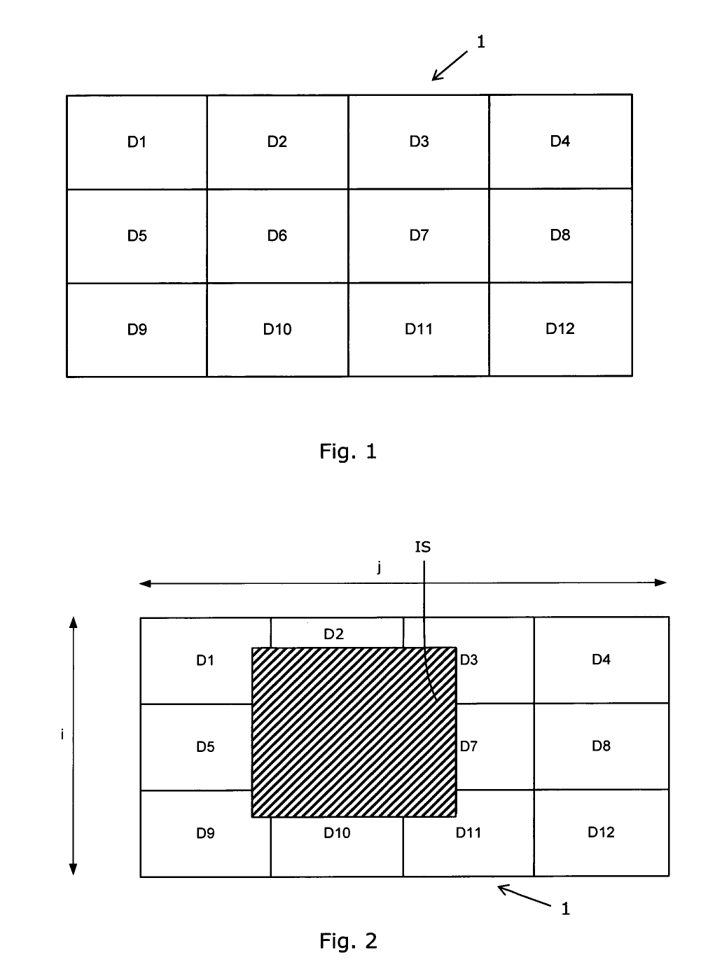

FIG. 1 shows an example of a display wall with 3×4 displays,

FIG. 2 shows an example of a video insertion on a display wall,

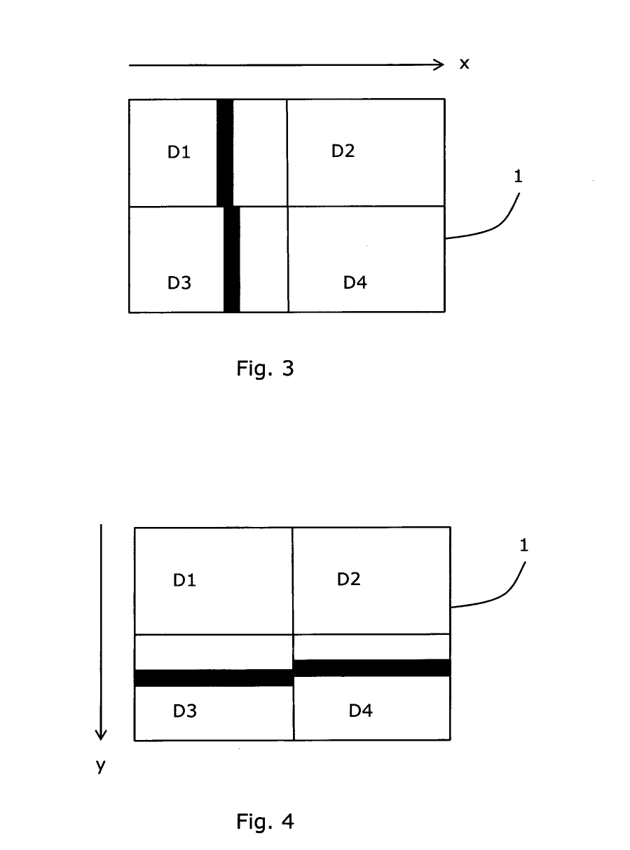

FIG. 3 shows an example of frame tearing with the horizontal movement of a vertical testing strip in a display wall,

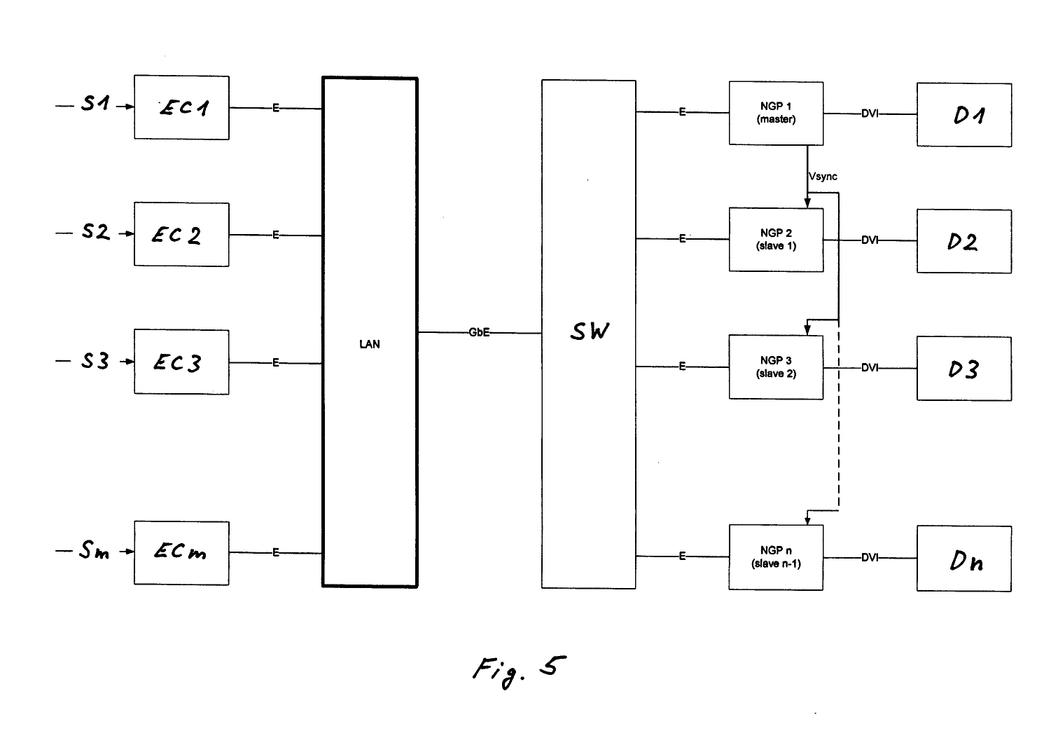

FIG. 4 shows an example for frame tearing with the vertical movement of a horizontal testing strip in a display wall,

FIG. 5 is a system configuration with frame lock,

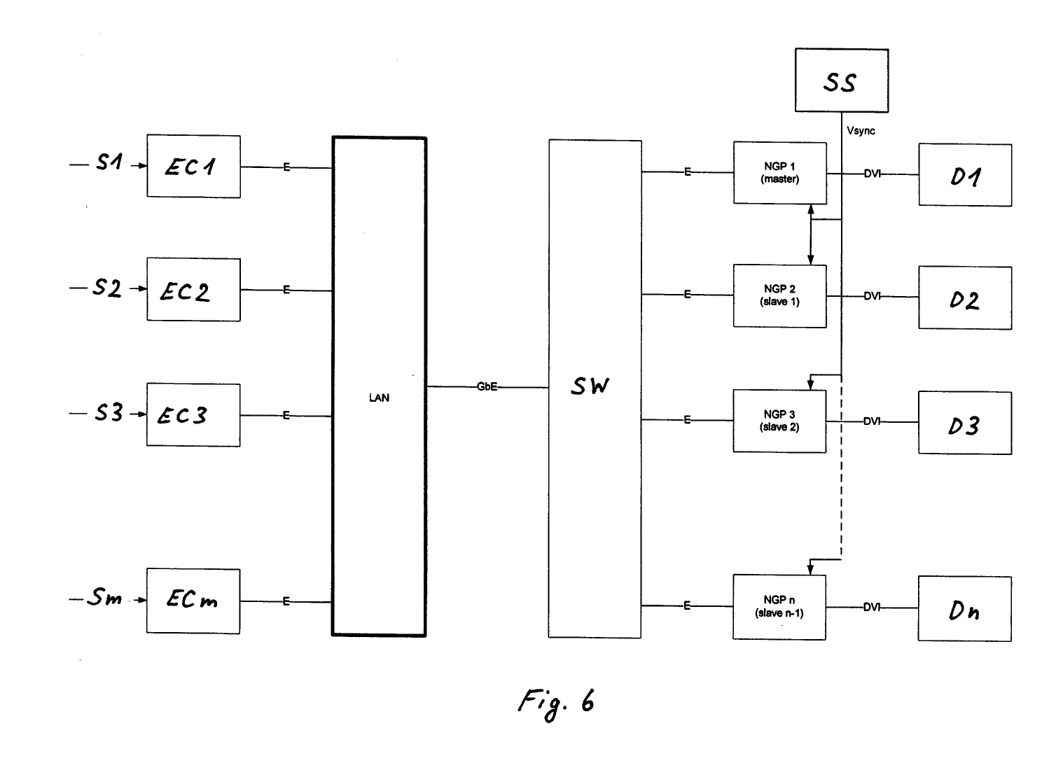

FIG. 6 is a system configuration with gen lock,

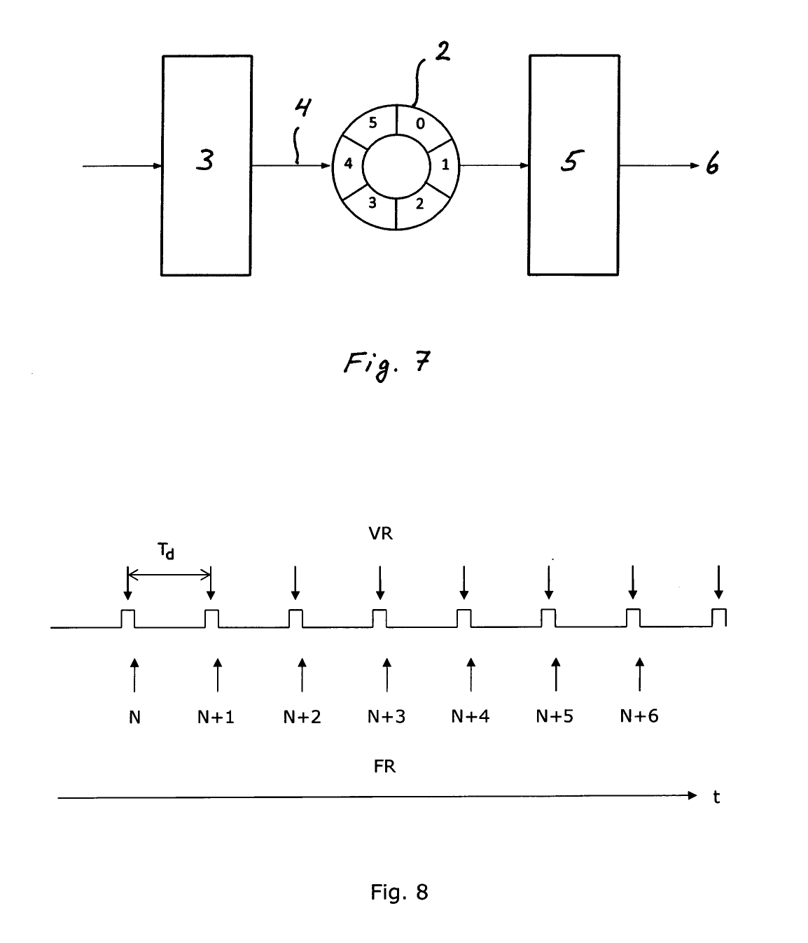

FIG. 7 shows an example of a video frame queue implemented as a ring buffer,

FIG. 8 shows the rendering of a video stream on a network graphics processor for fₛ=f_{d}, i.e. the video stream frequency fₛ is equal to the vertical display frequency f_{d},

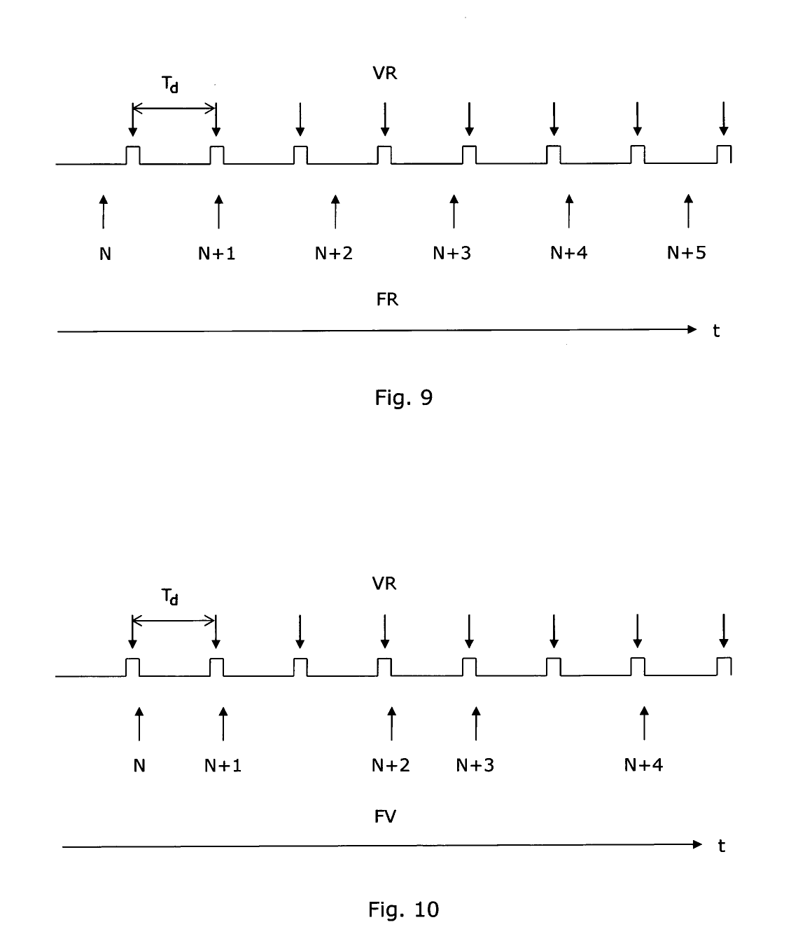

FIG. 9 shows the rendering of a video stream on a network graphics processor for fₛ<f_{d},

FIG. 10 shows the appearance of the video frames from FIG. 9 on a display,

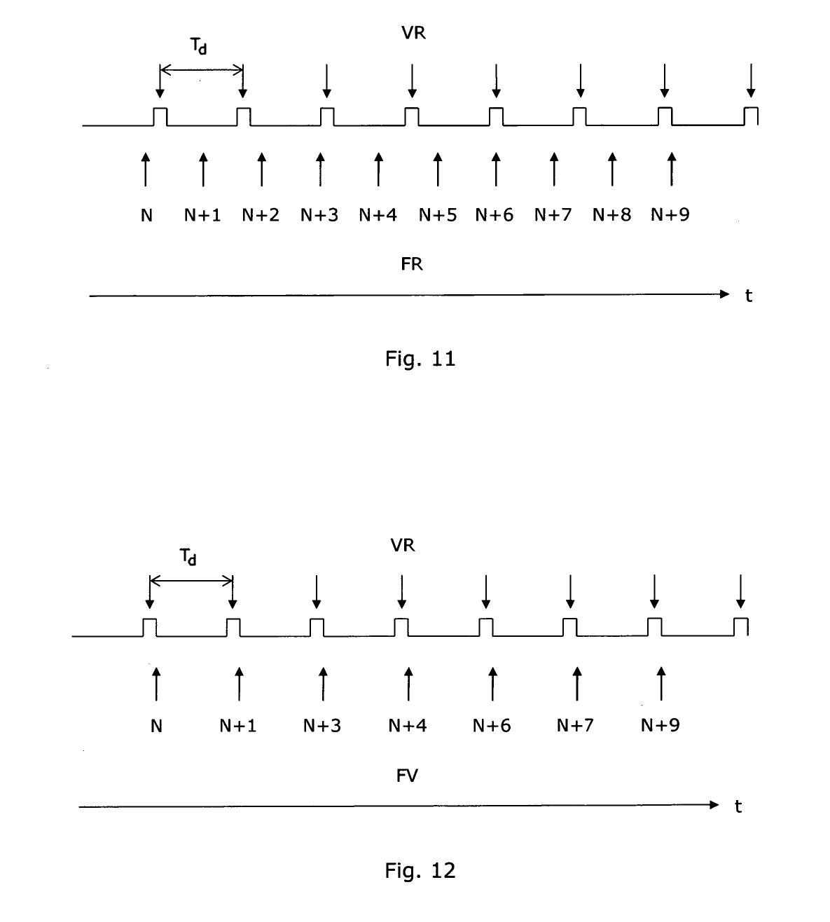

FIG. 11 shows the rendering of a video stream on a network graphics processor for fₛ>f_{d},

FIG. 12 shows the appearance of the video frames from FIG. 11 on a display,

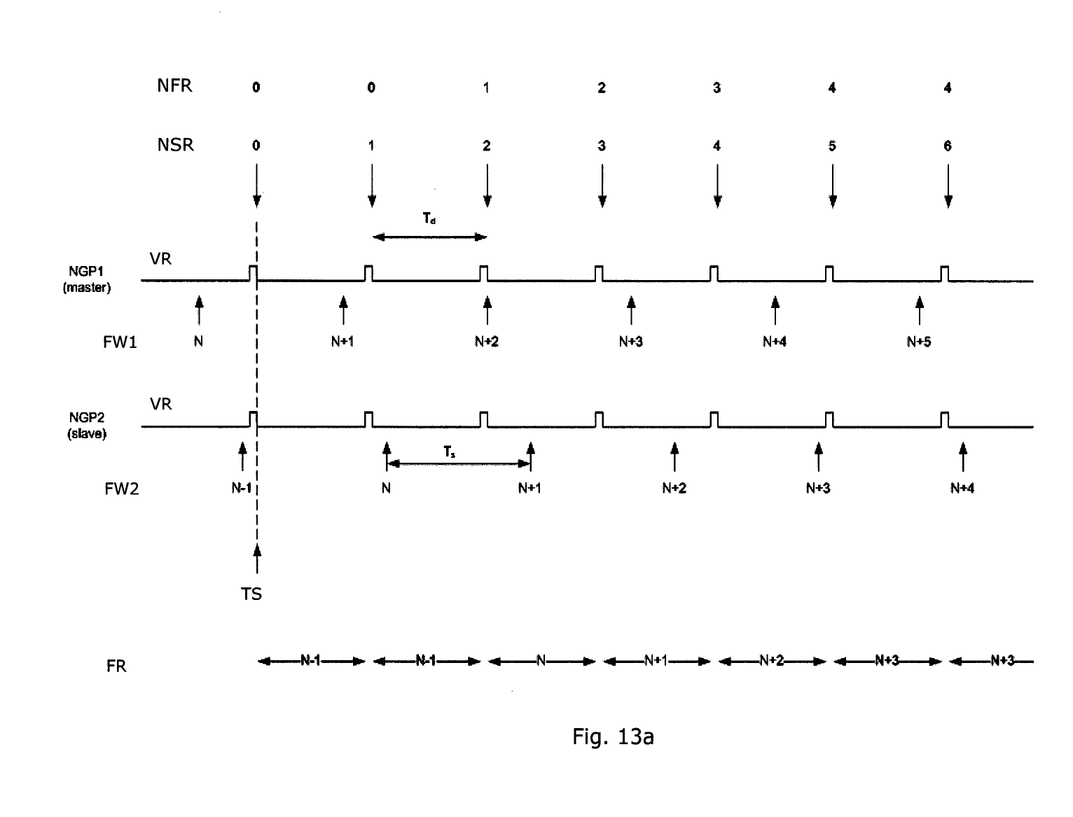

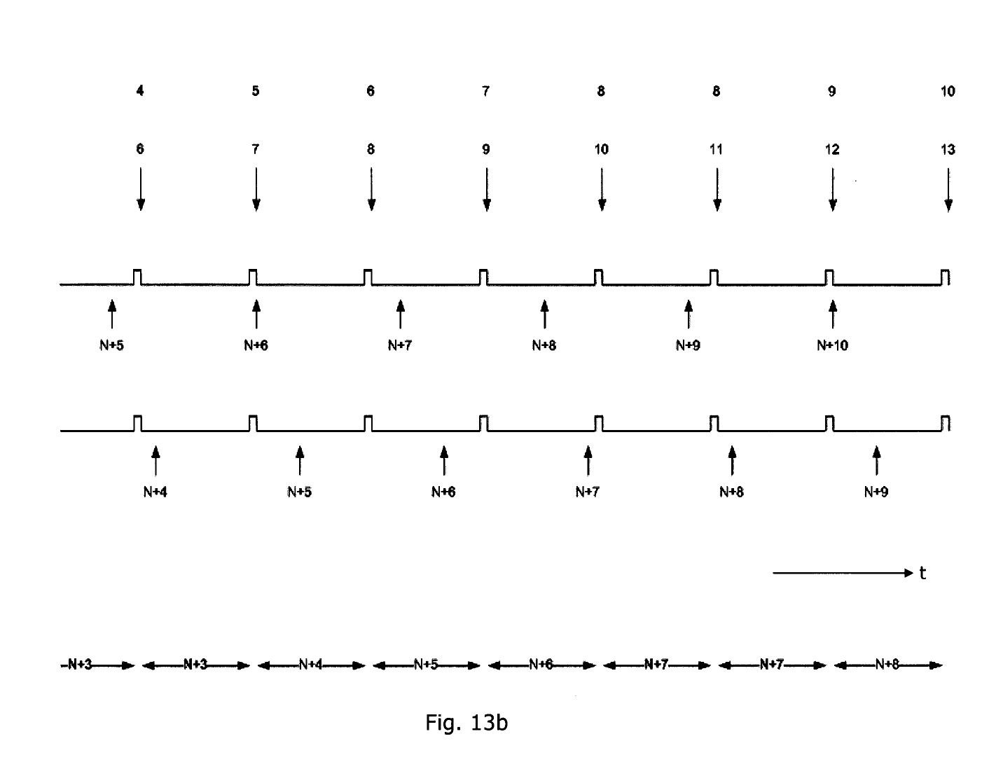

FIG. 13 shows the synchronization of two network graphics processors for a video image source,

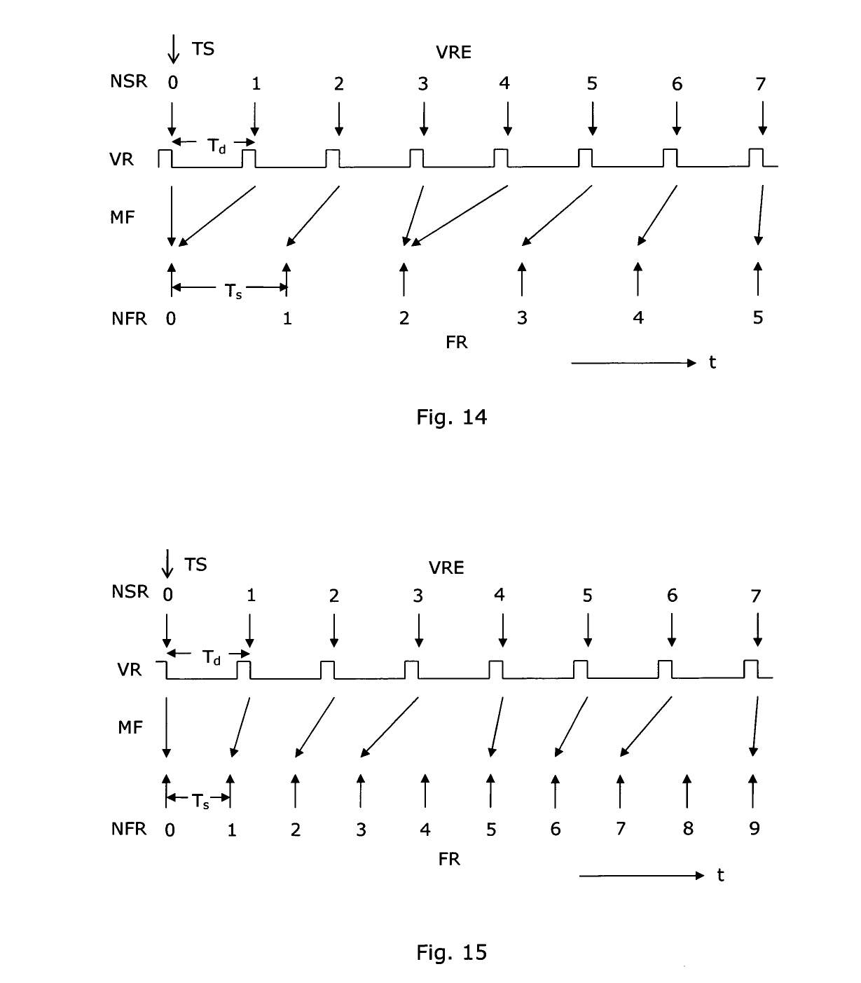

FIG. 14 shows the effect of a mediation function for the case fₛ<f_{d},

FIG. 15 shows the effect of a mediation function for the case fₛ>f_{d},

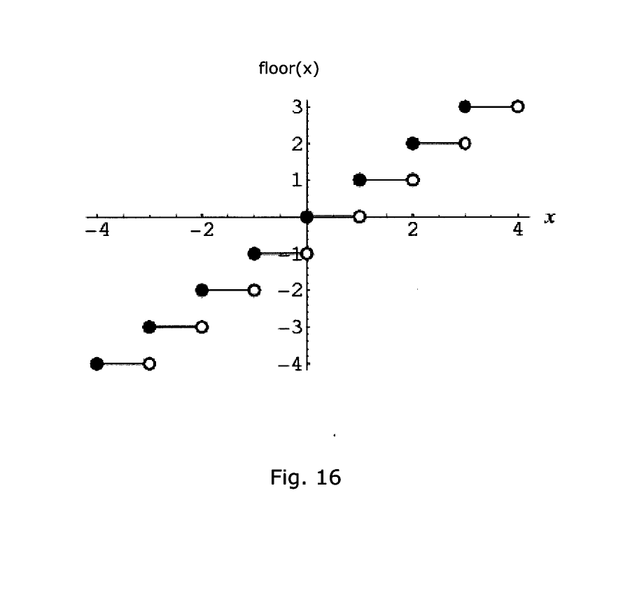

FIG. 16 shows the function floor(x),

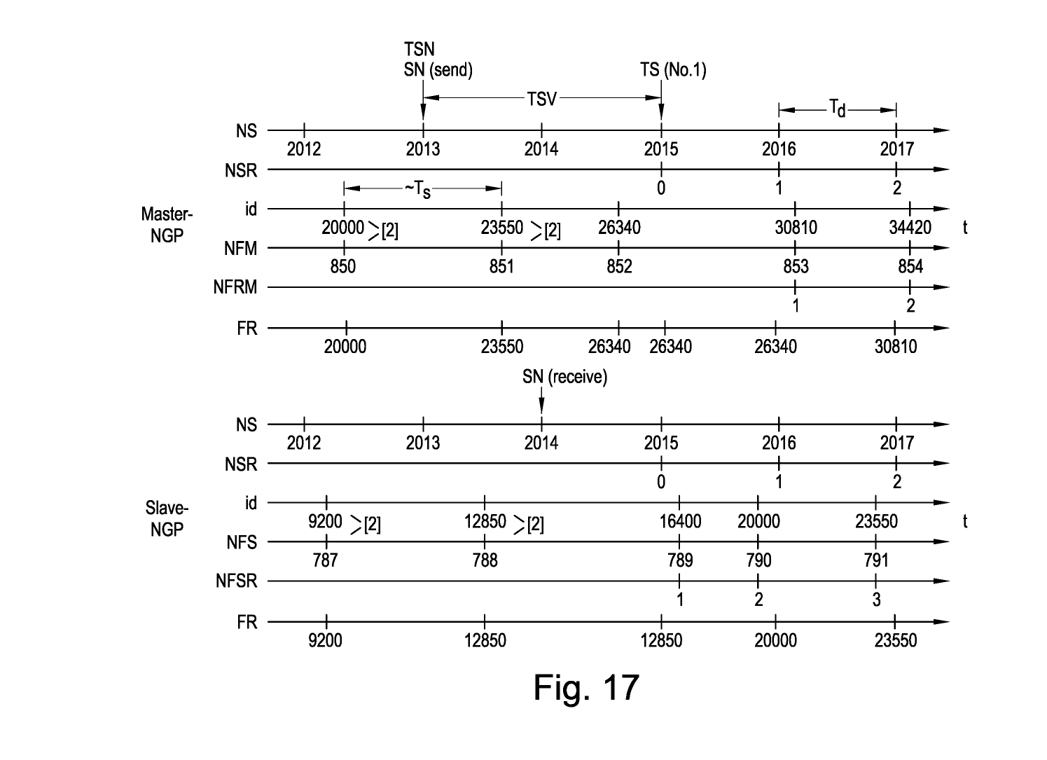

FIG. 17 is a first preparatory stage of the synchronization process,

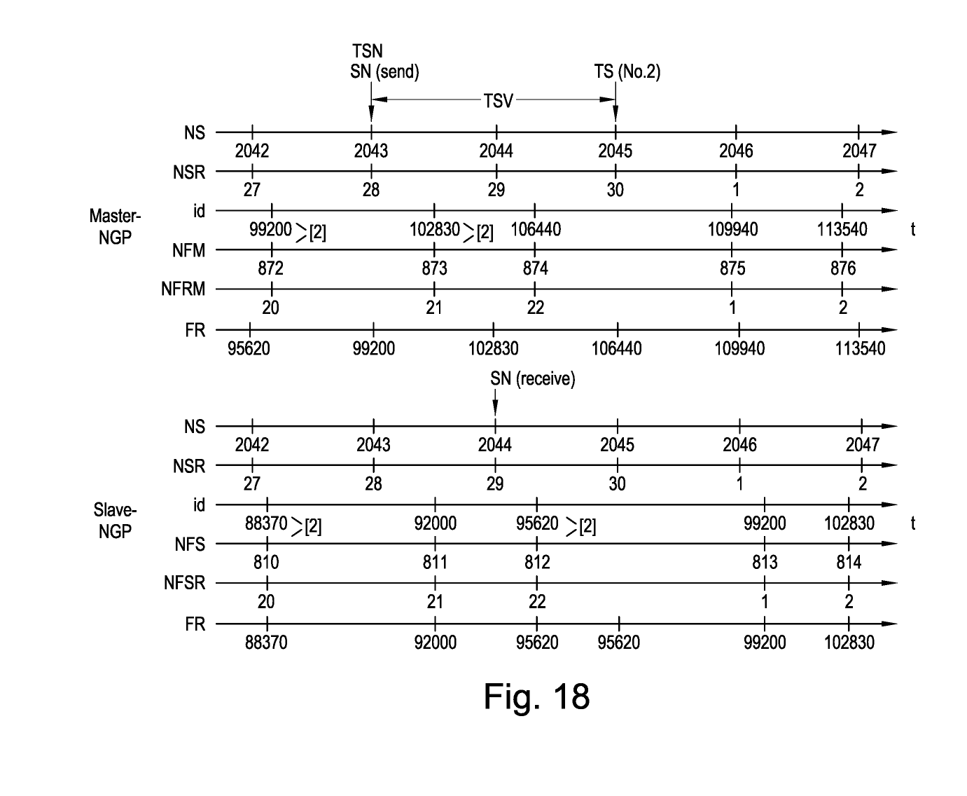

FIG. 18 is a second preparation stage of the synchronization process,

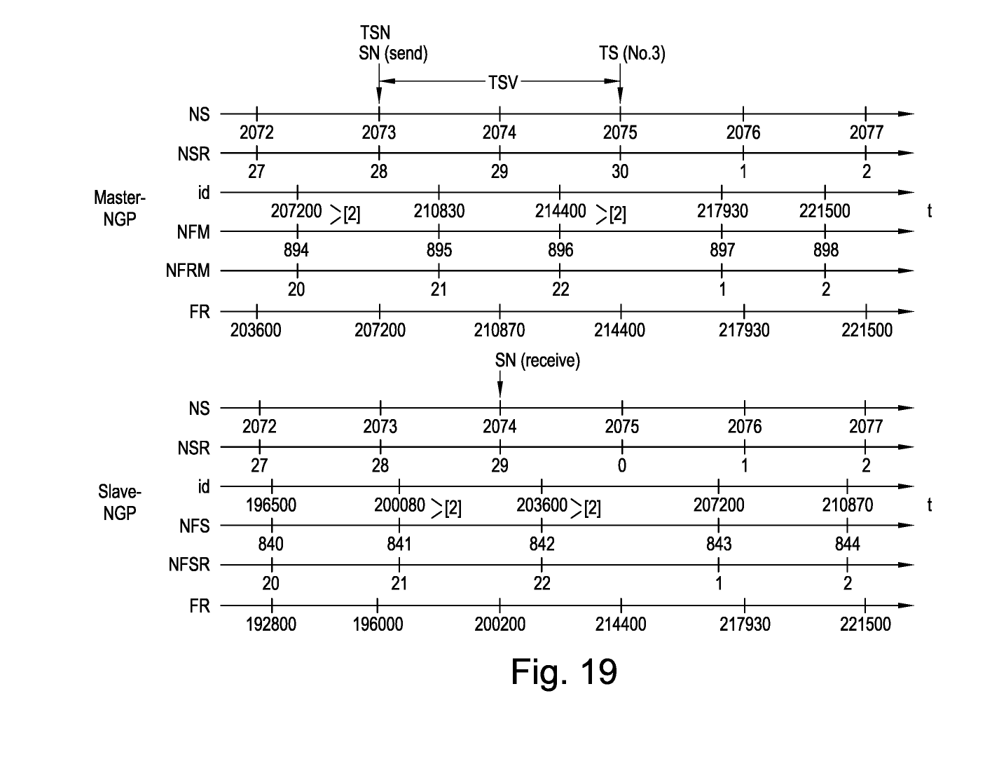

FIG. 19 shows the synchronization process and

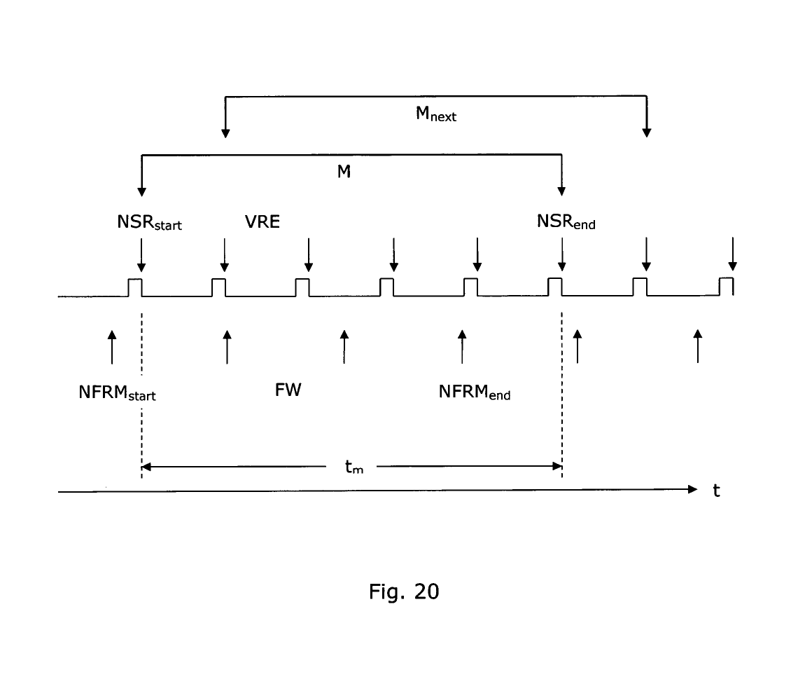

FIG. 20 shows the measuring of the frequencies fₛ and f_{d}.

FIG. 1 shows a top view of the display D of an examplary display wall 1 with 3×4 displays D. A display wall 1 which is also referred to as a video wall, generally comprises a plurality n of displays D (D1, D2, . . . , Dn), for example, projection modules (rear projection or incident light) or LCDs. The architecture of the display wall 1 includes n adjacent displays D in a matrix array with i rows and j columns, i.e. i×j=n. The n displays D have the same display frequency f_{d}, and preferably the same size and resolution.

The video image sources S to be displayed by the displays D of the display wall 1 is a plurality of m videos or video image sources S (S1, S2, . . . , Sm). These videos are each a data stream of frames, i.e. a video stream of video frames. Many successive, individual frames make up a video or a movie. The individual frames shown by a display D, taken from a video or film sequence that comprises many individual frames, are referred to as video frames. The video image sources S have video stream frequencies fₛ which can be different from one another as well as different from the vertical display frequency f_{d}.

While the notation as video image source S (or source) refers to the producer or source side (for example, an encoder which delivers the video as a video image source) of the video data stream, the presentations on the displays D of the display wall 1, derived from the video streams of the video image sources S, are referred to as video insertions IS. From the m video image sources S, a certain number of video insertions IS is obtained and displayed on the display wall 1. It is possible for a single video insertion IS to be only a part of the image of a video image source S (so-called “cropping”), or an entire image of a video image source S. The images of a video image source S can also be displayed in plural as multiple video insertions IS on one or more displays D. The same applies for parts of the images of a video image source S. In general, the number of video insertions IS is greater than or equal to the number m of the video image sources S. In the practically most frequent case, each video image source S is only displayed once on the display wall 1. In this case, the number of video insertions IS is equal to the number m of the video image sources S.

FIG. 2 shows an example of a logical video insertion IS on the display wall 1 of FIG. 1. The spatial area of a video insertion IS shown on a display wall 1 will generally extend across multiple displays D, wherein together, the partial video insertions form a logical video insertion IS on the relevant displays D. In FIG. 2, the superimposed area of the video insertion IS extends over the entire display D6 and parts of displays D1, D2, D3, D5, D7, D9, D10 and D11, whereas the displays D4, D8 and D12 are not involved in the display of the video insertion IS.

Due to various effects, in particular due to different transfer durations (network latencies) from the encoders of the video image sources S to the network graphics processors of the displays D and/or due to different processing times (processing delays) of the network graphics processors participating in image generation on the displays D, which are, for example, caused by different CPU loads, it may happen that a particular video frame of the video stream of a logical video insertion IS on a display D is displayed with a small time lag (or generally with a small time difference) as compared to the other displays D. This means that while a video frame i is shown on a display D at one instant of time, at the same time, one or more video frames, which temporally precede in the video stream, e.g. video frame (i−1) or (i−2), or one or more video frames arriving later in the video stream, e.g. video frame (i+1) or (i+2), are displayed on one or more other displays D of the display wall 1.

This leads to an effect which is generally called tearing (from English “to tear”=to separate apart, in German may be described as “single image tearing” or “line tearing”). Other reasons that lead to tearing in the presentation on the display D of a display wall 1, consist of the fact that the various video image sources S that are distributed encoded via the network can come from video image sources S with differing frame rates, and that the frame rates of the video image sources S can differ from the refresh frequencies (vertical display frequencies) of the displays D.

The known tearing is an undesirable effect (a so-called “artifact”) when displaying moving images on a single display D, e.g. a computer monitor or a digital television. Tearing is a visual artifact in video presentations that occurs when a video display D presents the information of one or more video frames in a single image rolling. This effect may occur when the structure and display of the individual frames is not synchronized with the monitor display, for example, the refresh frequency (refresh rate, vertical frequency, vertical display frequency) or the rolling. This may be due to the lack of adjustment of the refresh frequency. In this case, the tear line moves at a rate that is proportional to the frequency difference when the phase difference changes. It may, however, also simply be due to a lack of synchronization of the phase between same frame rates. In this case, the tear line sits at a fixed location which corresponds to the phase difference.

When displaying moving images or panning the camera, tearing leads to a torn appearance of the edges of straight objects which are no longer seamlessly connected. The viewer then sees several parts of successive frames at the same time, i.e. the images appear “torn”. This can be remedied through multi-buffering, e.g. double buffering in the generation and presentation of images, by alternately writing the individual images to two storage areas, one of which is always visible. These memory areas are then switched synchronously with the refresh frequency of the monitor, about 60 times per second, during vertical synchronization (Vsync), whereby the image change becomes “invisible”. This principle works in the same way with 30 Hz or 15 Hz, only that the monitor displays each image a little while longer. This tearing effect is particularly disturbing at higher resolutions, whereat depending on the structure of the monitor panel, vertical or horizontal tearing, or even tearing in both directions, can occur.

To avoid the known tearing in a single display D, mostly both multi-buffering such as double buffering, and vertical synchronization are used. The graphics card is prevented from doing something visible in the display memory until the display memory has finished its current refresh cycle, and during the vertical blanking interval, the controller either causes the graphics card to copy the non-visible graphic area into the active display area, or it treats both memory areas as displayable and simply switches between the two. In vertical synchronization, the frame rate of the rendering engine is exactly the same as the refresh rate (vertical display frequency) of the monitor. However, it also has some disadvantages such as judder, which is due to the fact that videos are usually recorded with a lower frame rate (24-30 video frames/sec) than the refresh rate of the monitor (typically 60 Hz). The resulting, regular missing of starting points and the slightly too frequent display of intermediate frames leads to an image flutter.

Thus, while in the state of the art already a significant technical effort is made to avoid the tearing during presentation on a single display D, the known measures used therein do not solve the problem described above, which is that because of the described transit time differences, at a specific time video frames which pertain to different times in the video stream can be displayed on the displays D of a display wall 1. This optical effect which occurs with display walls 1 can also be referred to as “tearing effect” and is particularly disturbing when presenting horizontally or vertically moving objects at the edges of the displays D presenting the object, because at the transition from one display to the adjacent display, the object appears “torn apart”. This effect occurs all the more, the greater the refresh rate (vertical display frequency) is and the resolution of the displays D. The effect is illustrated in FIGS. 3 and 4, in which a test signal commonly used for carrying out reproducible tests and extending over two adjacent displays D is shown in the form of a horizontally and vertically traveling bar or testing strip.

FIG. 3 shows an example of frame tearing in a display wall 1 with horizontal motion (in the direction of +x) of a vertical bar. The display D3 shows the video frame i, and at the same moment in time, the adjacent display D1 shows the antecedent video frame (i−1). This leads to tearing, i.e. to an offset in the presentation of the bar at the transition between the displays D1 and D3, whereat the offset is greater, the greater the speed of the moving bar is. The offset distorts the display of the bar and appears disturbing to an observer. The offset is all the greater, the greater the speed of the moving bar is.

FIG. 4 shows an example of frame tearing in a display wall 1 with vertical movement (in the direction of +y) of a horizontal bar. The display D3 shows the video frame i, and at the same moment in time the adjacent display D4 shows the previous video frame (i−1). This leads to tearing, i.e. to an offset which falsifies the presentation on the display of the bar at the transition between the displays D3 and D4, whereat the offset is all the greater, the greater the speed of the moving bar is.

When looking at a display wall 1, already an offset of the presentation of an object on adjacent displays by one video frame is noticeable (rubber band effect). In practice, without the synchronization of the display of the video frames according to the invention, the temporal frame offset on the displays D of a display wall 1 is from +/−1 up to max. +/−3 video frames. However, when presenting a video insertion on adjacent displays D, even a difference of +/−1 video frame is visible, especially when displaying fast moving objects and because the frame offset fluctuates, and should therefore be prevented by synchronization. In practice it is usually sufficient, however, to use the invention to correct a deviation of +/−3 video frames (i.e. three consecutive vertical retraces) with the video frame queues and the mediation function.

To avoid this visible artifact of frame tearing in a display wall 1, it is important that at a moment of time on the various (physical) displays D of display wall 1, the exact same video frames of a logical video insertion IS are displayed. The presentation of the video frames of a video insertion IS on the displays D of a display wall 1 must therefore be synchronized in terms of frequency and phase in order to avoid that at a moment of time the displays D show different video frames.

To avoid the above-described two types of tearing when displaying video image sources on a display wall 1, the following three measures are preferred according to the invention:
(i) Multi-buffering, preferably double buffering, and swap-locking on each of the network graphics processors NGP which control a single display D of the display wall 1.
(ii) The synchronization of the vertical retraces of the graphics cards in the individual displays (frame locking or gen locking).
(iii) Content locking. The display of video frames of a video image source S is hereby synchronized in such a way that at the same moment of time on each of the participating displays D exactly the same video frames of said video image source, which belong to a logical video insertion IS, are displayed.

The following explains how the tearing free operation according to the invention is achieved, in particular by means of an content locking according to the invention.

According to the invention, the display of the video frames is preferably performed multi-buffered, preferably double buffered, and swap-locked, using the network graphics processors NGP. These terms refer to the process of how the image data (video frames) stored in a buffer memory of a network graphics processor NGP come to be presented on the associated display D. During double buffering, two buffer memories are used, namely a front buffer (or visible buffer) which contains the image data that is currently displayed on the display D, and a back buffer which contains the image data of the next video frame. Double-buffering therefore designates that the onboard memory in the graphics card of the network graphics processor NGP has two memory areas, namely a visible range which is read out for display into the display D, and a back buffer area that is controlled by the GPU. During multi-buffering, appropriate, additional buffers are used. During swap-locking operation, the copying from the back buffer to the front buffer or the swapping of the roles of these buffer areas (buffer-flipping) is performed in the vertical blanking interval (vertical retrace, image refresh) of the display D. The swapping can either be a genuine copying or a buffer-flipping, i.e. a true exchange of the memory areas. During the exchange, the buffer contents are not exchanged but rather the reading is carried out from the other buffer. With the multi-buffering or double buffering and the swap-locked memory operation, tearing is avoided during image composition on a single display D. This switch over can be a copying from the concealed to the visible memory area, or the video controller on the graphics card swaps the roles of these two storage areas such as hardware would do, which is known as buffer-flipping.

Rendering is defined as the transformation or conversion of a geometric image description, for example a vector graphic, into a pixel presentation. The rendering of video frames using OpenGL can be performed double buffered and swap-locked. OpenGL is a graphic subsystem that specifically allows rendering with texture, whereat for the rendering of video frames the frame content is mapped as a texture onto the rectangular presentation of the video insertion. Double-buffering means that the video frames are rendered into a back buffer which contents are not visible on the display D. And this is done while the previous video frame contained in the front buffer is displayed. If a swap-buffer-function (an OpenGL library function) is activated, the back buffer and the front buffer are exchanged (swapped), i.e. the back buffer becomes the new front buffer which information is read out and visible on the display D, and the front buffer becomes the new back buffer for the rendering process of the next video frame.

Swap-locking means that this buffer exchange is performed during the vertical blanking interval (the vertical retrace, image return, display retrace, display return) of the display D. The swap buffer function can be activated at any time, but the back buffer is copied into the front buffer only during the next vertical blanking interval of the display D. This prevents tearing in each individual, shown image of a display D.

According to the invention, the vertical retraces of the graphics cards which drive the displays D are synchronized in the network graphics processors, which means that the vertical retrace signals have the very same frequency and the same phase. A possible method of implementation is that a computer with a graphics processor, in this case a network graphics processor NGP, is configured as a master which, for example, delivers the vertical retrace signal Vsync via a multi-drop cable to each computer with a graphics processor. This variant is called “frame lock” and is illustrated in FIG. 5. The slaves are configured in such a way that they obey this signal and lock their synchronization at this vertical retrace signal Vsync. Another method is, for example, to lock each network graphics processor NGP according to the same, external vertical retrace signal Vsync via a multi-drop cable. This external synchronization signal Vsync is then provided by a synchronization transducer SS. This implementation is also called “gen lock” and is shown in FIG. 6.

A hardware synchronization of the vertical retrace signals Vsync of the displays D across multiple graphics processors NGP, for example using frame lock or gen lock, can be realized by a specific, additional frame lock hardware. For example, the G-Sync board is commercially available from NVIDIA Corp., Santa Clara, Calif., USA. However, the Vsync signals can also be synchronized with software, for example by means of multicast messages over the network. The synchronization of the vertical retraces of the displays D in terms of frequency and phase is typically carried out in practice with an accuracy of 1 msec or better.

The vertical retraces of the displays D of the display wall 1 are thus synchronized with vertical retrace signals Vsync in terms of frequency and phase. In the implementation in software according to the invention, the vertical retrace signals Vsync are counted up by a synchronized vertical retrace signal counter (synchronized Vsync counter NS) from one vertical retrace signal Vsync to the next, i.e. from one vertical retrace to the next. The current value of the vertical retrace signal counter (synchronized Vsync counter NS) is transmitted along with the vertical retrace signals Vsync to the network graphics processors NGP so that at the same moments of time, the same values of the vertical retrace signal counter (synchronized Vsync counter NS) are available on the network graphics processors NGP.

Without synchronization of the Vsync signals, for example by means of frame lock or gen lock, frame tearing between the displays D would appear on the display wall 1. The fundamental source of the frame tearing in this case is different from the above-described frame tearing phenomenon on a single display D. Without synchronizing the Vsync signals of all network graphics processors NGP to the very same frequency and phase, for example, by means of frame lock or gen lock, the frame tearing would be caused by the phase difference of the vertical scanning (the vertical process of image display) of adjacent displays D, which would lead to an outer-phase presentation on various displays D of the video frames shown on the displays D.

To ensure tearing free operation between the images shown by the displays D of a display wall 1, it is therefore necessary that the vertical retrace signals Vsync of all network graphics processors NGP have the very same frequency and phase, for example, by performing a frame lock or gen lock. Thus, the basic condition is met that the image formation on the displays D takes place with the very same frequency and phase.

FIG. 5 shows a system configuration with frame lock, and FIG. 6 a system configuration with gen lock. The video image sources S to be displayed by the n displays D1, D2, . . . , Dn of the display wall 1 are a plurality of m videos or video image sources S (S1, S2, . . . , Sm). These videos are each a data stream of images, i.e. a video stream of video frames. The displays D are a plurality of displays (D1, D2, . . . , Dn), for example, projection cubes (rear projection or incident light) or LCDs, each driven from a separate network graphics processor NGP (NGP 1, NGP 2, . . . , NGP n). A network graphics processor NGP which is also referred to as a render engine or rendering engine, is the generic term for a dedicated display controller with a LAN connection, a CPU, a memory, a hard drive, an operating system (such as Linux), software decoders and/or hardware decoders, a graphics processor, and all other components that are necessary for its functionality. The display output of each network graphics processor NGP is connected via a video display interface, e.g. a Digital Visual Interface (DVI), with one display D each. A display D and an associated network graphics processor NGP are collectively referred to as a display unit.

The videos of the video image sources S can be encoded. The encoding is performed in each case by means of an encoder EC and is a compression technique used to reduce the redundancy in video data and consequently to reduce the bandwidth required in the network to transfer the videos to the video image source S. MPEG2, MPEG4, H.264 and JPEG2000 are examples of common standards of compression techniques for encoding video. It is possible that some, many, or all of the video image sources (S1, S2, . . . , Sm) are encoded. The encoders EC can be a mixture of encoders from different manufacturers, e.g. i5210-E (by Impath Networks Inc. Canada), VBrick 9000 series (by VBrick Systems Inc.) and VIP1000 (Bosch). On these encoders EC, variants of standard communication protocols are implemented. It may also be that uncompressed video image sources S are transmitted to the network graphics processors NGP of the display wall 1. However, the transmission of uncompressed video causes a higher load on the network.

The data stream of video images of the video image sources S compressed by the encoders EC is transmitted to the network graphics processors NGP over a network LAN or IP network (e.g. a general purpose LAN or a dedicated video LAN) and possible network switches SW. The computer network LAN can be, e.g. a Gigabit Ethernet GbE IEEE 802.3-2008 and/or an Ethernet network E. The transmission of video images over the network LAN takes place, for example, with the so-called UDP Multicast. In computer networks, multicast is the simultaneous sending of a message or information from one transmitter (the video image source S) to a group of recipients (receiving computers, network graphics processors NGP) in a single transmission from the transmitting party to the receiving parties. The advantage of multicast is that messages can be simultaneously transferred to several users or to a closed user group without the transmitter bandwidth multiplying by the number of receivers. Multicast is the common term for IP multicast which enables you to efficiently send packets in IP networks to many recipients at the same time.

By means of decoders in the network graphics processors NGP, the video streams received over the network LAN are again decoded for display on the displays D and are shown by the displays D. The decoders can be hardware and/or software decoders. The decoder function can handle the various compression standards such as MPEG2, MPEG4, MJPEG and H.264.

That means that all m video image sources S are sent over the LAN IP-network to all network graphics processors NGP and are presented by the displays D of the display wall 1 in a particular composition. However, the network graphics processors NGP do not decide themselves which video image source S or video image sources S, or which part or parts of a video image source S, they present on the display D with which they are respectively associated. Instead, this is controlled by a central instance or central processing unit which is not shown. The presentation of the video image sources 1 on the displays D of the display wall 1 takes place according to a specific layout that is predefined by the central instance not shown. The central instance tells the network graphics processors NGP which part of which video image source S the display D associated with each network graphics processor NGP shall be presented where on the display D.

To transmit the video image sources S via the network LAN to the network graphics processors NGP, usually two networks are used, namely a video network that transmits all video image sources S to all network graphics processors NGP, and a control or home network which supplies the control information for the individual display units from the central control. The control information thereby indicates which video image source S, or which part of a video image source S, is to be presented from which display D where on the display D.

It is clear that every network graphics processor NGP involved in the display of a logical video insertion IS from the network LAN must receive the same video data stream, then decode it and present on its associated display D the part of the logical video insertion IS which corresponds to the respective display D of the display wall 1 that is controlled by the respective network graphics processor NGP.

As explained above, due to various transfer durations (network latency) between the encoders EC and the network graphics processors NGP and/or different CPU loads of the participating network graphics processors NGP, a particular video frame of a video stream of a video image source S can be presented on a display D of the display wall 1 with a small time lag as compared to other displays D of the display wall 1. While, for example, the video frame i is displayed on a display D of the display wall 1, one or more prior video frames, e.g. the video frames (i−1) or (i−2), may at the same time be displayed on other displays D of the display wall 1. This leads to the visible artifact which is called “tearing effect” or “frame tearing”.

The synchronization of the vertical retrace signals Vsync of the displays D, particularly by means of frame lock or gen lock, is thus not enough to achieve a tearing free operation of the display wall 1, because as explained above, due to various transfer durations (network latency) between the encoders EC and the network graphics processors NGP and/or different CPU loads of the participating network graphics processors NGP, it may be the case that a particular video frame of a video stream of a video image source S is displayed on a display D of the display wall 1 with a small time lag as compared to other displays D of the display wall 1, even if the vertical retrace signals Vsync of the displays D, and thus the image presentations on the displays D, are synchronized in terms of frequency and phase. In order to ensure tearing free operation between the images shown by the displays D of a display wall 1, it is also necessary that at the same moment of time on each of the participating displays D, exactly the same video frames of a given video image source S belonging to a logical video insertion IS, are shown. This condition is referred to as “content lock” and the method for implementation as “content synchronization” or “content locking”.

The synchronization of the vertical retrace signals Vsync of the displays D, for example by means of frame lock or gen lock, is therefore a necessary, but not a sufficient, condition for content lock. In order to avoid the visible artifact of the frame tearing, it is essential that at the same moments of time exactly the same video frames of a logical video insertion IS are presented (in phase) on the different (physical) displays D. This means that the display of video frames needs to be synchronized by content lock between the network graphics processors NGP which participate in the display of a video insertion IS.

The content synchronization according to the invention for synchronizing the display of video frames on the displays D in such a way, that at the same moment of time exactly the same video frames of a given video image source S belonging to a logical video insertion IS are presented on each of the participating displays D, comprises the following parts:
(a) Synchronization of the clocks on the network graphics processors NGP, preferably by PTP.
(b) Buffering of the video frames in a video frame queue on every network graphics processor NGP.
(c) Use of a mediation function to de-jitter.
(d) Content locking by synchronizing the moments of time at which the mediation function restarts on all participating NGPs (frame synchronization points of time), by synchronizing the parameter frequency ratio (video stream frequency fₛ divided by the display frequency f_{d}) of this function, and by synchronizing the video frame which is selected from the video frame queue for rendering at this time.

In the context of the invention, preferably the Precision Time Protocol (PTP) is used to synchronize the clocks on the network graphics processors NGP, also known as IEEE 1588-2008. It is a networking protocol that effects the synchronicity of the clock time adjustments of multiple devices on a computer network. It is a protocol that is used to synchronize the clocks of computers in a packet-switched computer network with variable latency. The computers of the network are organized in a master-slave architecture. The synchronization protocol determines the time offset of the slave clocks relative to the master clock.

In the context of the invention, the PTP can be used to synchronize the various network graphics processors NGP. For this purpose, a network graphics processor NGP serves as a reference (PTP master) and the clocks of all other network graphics processors NGP are synchronized with high accuracy according to this PTP master. The time of the PTP master is referred to as the system time. The time variations of the network graphics processor NGP clocks versus the PTP master clock can be kept below 100 μs.

In principle, one could consider performing a content lock, i.e. a content synchronization, with an exact system time and based on the time stamp of video frames. A video frame contains the encoded content of a complete video frame of a particular video image source S. Each video frame is uniquely identified by the timestamp in the RTP (Real-Time Transport Protocol) packet header. However, it was found that many implementations of RTP have insufficiently reliable or incorrect timestamps. Because of this uncertainty with the timestamps, in the context of the invention, the time stamp is not used for any purpose in connection with its time indication, but only as an identifier (absolute frame identification number) for the video frame.

According to the invention, the content lock, i.e. the content synchronization, is done by means of buffering video frames in a video frame queue and with a frame synchronization process which uses a mediation function. The aspects and concepts are explained below.

The video frames of an encoded video signal, i.e. of a video image source S, which is distributed over a computer network LAN do not arrive in a time-equidistant manner in the various network graphics processors NGP of the displays D. The video frames may occur in bundles or intermittently, and then there may be a period in which no video frames arrive. In the case of a video image source S with a frame rate of 50 Hz, the average period length with which the video frames are received is 20 ms, if this average is measured over a sufficiently long period of, for example, 2 s. Considered over shorter time intervals, the video frames can arrive at time intervals which are much shorter or much longer than 20 ms. These temporal fluctuations are called video jitter. Jitter refers to a non-uniform, temporal spacing of video frames when displaying successive video frames.

The causes of jitter are essentially the decoders, the network LAN and the network graphics processors NGP, but also other components such as the encoders EC can contribute to jitter. Jitter makes it necessary to de-jitter the incoming video stream so that moving content can be displayed without jitter artifacts. For this purpose, the decoded video frames of the video streams are buffered in a video frame queue 2. In the context of the invention, this video frame queue 2 is preferably implemented as a ring buffer since here, video frames can be revolvingly entered anew, and video frames are removed for rendering without the requirement that they have to be copied.

FIG. 7 shows such a video frame queue 2 implemented as a ring buffer. The ring buffer has a fixed number of places for possible entries (in the example of FIG. 7, six places with the indices 0 to 5). A ring buffer is implemented in software as an array, wherein the ring structure is accomplished by the handling of put and get pointers.

Per video image source S, a video frame queue 2, for example, a ring buffer according to FIG. 7, is provided in each network graphics processor NGP to which the video frames of the video image source S are transmitted. For unencoded video image sources S, video frames are entered directly into the video frame queue 2, whereas for encoded video image sources S, the video frames are first decoded by the decoder 3. The decoder 3 receives a coded stream of video frames, performs the decoding and enters the decoded video frames 4 in the ring buffer. The first video frame is entered in position 0 of the ring buffer, the next video frame in position 1 and so on until the last position 5 is occupied and it starts all over again at position 0. The reading of the memory locations of the ring buffer is done with the renderer 5 or a rendering process which supplies the back buffer 6 with video frames. Decoding with a decoder 3 and the rendering with a renderer 5 in FIG. 7 takes place in each network graphics processor NGP in two different processes. The renderers 5 each extract the video frame selected by the mediation function for rendering from the respective video frame queue 2. Older entries in the video frame queue 2 are already processed and therefore are considered to be invalidated, i.e. their positions in the queue are released for new entries. The put pointer of the video frame queue 2 points to the free position for the next video frame 4 provided by the decoder 3 and the get pointer to the position, which the mediation function has determined for the retrieval of the next video frame to be rendered. An entry in the video frame queue 2 is invalidated when the get pointer is set to another position of the video frame queue 2 by the mediation function.

For the content synchronization, which is performed with a frame synchronization process described below, it is important that the renderer 5 or the rendering process, being the recipient of the video frame queue 2 (the ring buffer in FIG. 7), extracts the video frames stored in the video frame queue 2 quickly enough for rendering out of the video frame queue 2, so that a memory location occupied in the video frame queue 2 with a video frame that is later still required for rendering, is not overwritten by a new decoding-write operation from the decoder 3. This is achieved in a video synchronization module through a mediation function which mediates between the video stream frequency fₛ of the incoming video stream of the video image source S and the vertical display frequency f_{d} (also called vertical frequency, display frequency, frame frequency, frame refresh rate, or refresh frequency) of the display D. The video synchronization module is part of the software that implements the synchronization in accordance with the invention and is part of the rendering in the network graphics processor NGP. The mediation function ensures a speed balancing between generator (decoder 3) and recipient (renderer 5) of the entries in the video frame queue 2, and determines which video frame is read out from the video frame queue 2 and further processed (rendered by the renderer 5).

An optimal size of the video frame queue 2 is given when it features an average filling ratio of about 50% during operation, i.e. is half-filled with valid and half-filled with invalid (processed) video frames 4. In this case, on the one hand, enough video frames 4 are cached in the video frame queue 2 so that the rendering can be performed in a de-jittered manner, and on the other hand, the queue is half empty and so has sufficient free memory locations for caching video frames 4 coming in from the video stream in quick succession without the video frame queue 2 overflowing. In practice, it is sufficient to have a video frame queue 2 which has about 5 to 15 spaces. If, however, longer time differences of video frames 4 occur than, for example, +/−3 video frames, the video frame queue 2 can be extended.

The display D itself defines the vertical display frequency f_{d} of the display D and other display settings. During the initial startup of the display wall 1 or the display D, f_{d} is defined by the “Display Data Channel” (DDC) protocol and the accompanying standard “Extended Display Identification Data” (EDID). The display settings and thus f_{d} are not changed during the operation of the system. The period T_{d} is derived as T_{d}=1/f_{d}. The vertical display frequency f_{d} of the display D usually falls within the range 50 Hz≦f_{d}≦100 Hz, but can also fall below or above this range.

The video stream frequency fₛ of the video stream is the ratio of the decoded video frames 4 at the output of the decoder 3 or at the input of the video frame queue 2. The period Tₛ is calculated as Tₛ=1/fₛ. Ideally, fₛ=f_{d}, but significant differences are possible. For example, the incoming video stream can have a rate fₛ of 60 Hz while the vertical display frequency f_{d} is only 50 Hz. In addition, the “momentary” (or “differential”) video stream frequency fₛ of the video stream can also vary over time because different video frames can take a different path through the network LAN, or because the transit times may vary due to changing network traffic (see also jitter as explained above). Another major cause for a fluctuating video stream frequency fₛ of a video stream are differences in the encoders EC or the different loads of the CPUs or graphics processors of the different network graphics processors NGP. Therefore, in general, fₛ≠f_{d}, whereat both fₛ<f_{d} and fₛ>f_{d} are possible. Moreover, the difference between fₛ and f_{d} may change during the operation of the display wall 1.

In FIGS. 8 to 12, the rendering of a video stream on a network graphics processor NGP is explained for three different cases
(1) fₛ=f_{d}
(2) fₛ<f_{d}
(3) fₛ>f_{d}

FIG. 8 shows the case (1), i.e. the processing of a video stream on a network graphics processor NGP for fₛ=f_{d}. The vertical retraces VR of the display D illustrated as rectangular pulses are shown as a function of time t and the numbers N, N+1, etc. of the video frames FR rendered into the back buffer. In this ideal situation hardly ever existing in practice, precisely one video frame of the video stream is rendered between two consecutive vertical retraces VR of the display D. No video frame needs to be skipped, and no video frame needs to be displayed longer than during the time period T_{d}. This does not apply in the cases (2) and (3) which are represented in the FIGS. 9 to 12.

FIG. 9 shows the case (2), i.e. the rendering of a video stream on a network graphics processor NGP for fₛ<f_{d}. The vertical retraces VR of the display D illustrated as rectangular pulses are shown as a function of time t and the numbers N, N+1 etc. of the video frames FR rendered into the back buffer 6. In contrast to FIG. 8, the points in time at which the video frames FR are rendered into the back buffer do not coincide with the points in time of the vertical retraces VR. The video frames FR rendered into the back buffer 6 are not yet visible, i.e. are not yet shown on the display D, but only when (after performing the swap buffer function) the image information is located in the front buffer. The points in time of the rendering of a video frame, and of the video frame becoming visible, are generally different. Here, we ideally assume for purposes of illustrating the principle that the video stream is absolutely jitter-free when the video frames come from the decoder 3, i.e. the video frames are available with a constant video stream frequency fₛ for rendering into the back buffer 6. It obviously cannot be, that in each period T_{d}, a new video frame is displayed between two vertical retraces VR, i.e. is copied into the front buffer as a video frame FV that is becoming visible, because it would contradict the condition fₛ<f_{d}. FIG. 9 shows when in this case the video frames actually become visible on the display D, and this is shown in FIG. 10.

FIG. 10 shows the appearing of the video frames FR rendered into the back buffer 6 of FIG. 9 as video frames FV becoming visible on the display D. It is apparent that inevitably some video frames (here, the video frames N+1 and N+3) are displayed during the period 2×T_{d}, i.e. during two frame times (or in other words, they are displayed again), in order to compensate for the fact that Tₛ>T_{d} (i.e. fₛ<f_{d}). This generally results in a somewhat abrupt movement of a displayed, moving object, such as a testing strip. Only if Tₛ is an integer multiple of t_{d} the movement will be uniform, but only with larger leaps of a displayed, moving object from one image phase to the next by a plurality of pixels than in the case (1), when the speed of the displayed, moving object is the same in both cases.

FIG. 11 shows the case (3), i.e. the display of a video stream on a network graphics processor NGP for fₛ>f_{d}. The vertical retraces VR of the display D illustrated as rectangular pulses are shown as a function of time t and the numbers N, N+1 etc. of the video frames FR rendered into the back buffer 6. In this case, it happens that the (ideal) rendering times of two successive video frames may fall between two consecutive vertical retraces VR in the same period T_{d}, so that the first video frame is overwritten before the next vertical retrace VR by the second video frame. As a result, this means that the first video frame is not visible, but is skipped. From FIG. 11 it is apparent which video frames are shown on the display D, and this is illustrated in FIG. 12.

FIG. 12 shows the appearance of the video frames FR of FIG. 11 rendered into the back buffer 6 as video frames FV becoming visible on the display D. This clearly shows that some video frames (in the example shown, the video frames N+2, N+5 and N+8) are inevitably skipped to compensate for the fact that Tₛ<T_{d} (i.e. fₛ>f_{d}). Also in this case, the movement of a displayed moving object, for example, a testing strip, will not be uniform except if T_{d} is an integer multiple of Tₛ.

The preceding considerations are obviously already valid for the display of a video (or video insertion IS) on a single network graphics processor NGP. If we now wish to synchronize a video stream on multiple network graphics processors NGP for the display of the video on not just one, but on several displays D, those video frames shown more than once or left out (in the above-mentioned sense) need to be the same on all participating network graphics processors NGP, so that frame tearing from one display to another is avoided. The following figures illustrate the synchronization of a video stream on multiple network graphics processors NGP.

In FIG. 13, we see an example in which two network graphics processors NGP 1 and NGP 2 must be synchronized to display a video stream in case of fₛ<f_{d}. FIG. 13 comprises two parts, namely a first part (FIG. 13a) with the video frames N to N+5 in the network graphics processor NGP 1, and a second part (FIG. 13b) with the video frames N+5 to N+10 in the network graphics processor NGP 1. FIG. 13b thus follows FIG. 13a with a small temporal overlap shown. FIG. 13 shows the synchronization of two network graphics processors NGP 1 and NGP 2 for the example case fₛ=40 Hz and f_{d}=50 Hz. The network graphics processor NGP 1 functions as the machine that takes the lead for the synchronization procedure for a specific video image source S. The processor is thus called a master and all other network graphics processors NGP are called slaves. Both displays D, each associated with one of the network graphics processors NGP, have the same vertical display frequency f_{d}. The graphics cards of network graphics processors NGP are synchronized, preferably frame locked or gen locked, for example with the hardware method described above. This means that the vertical retrace signals Vsync of the different network graphics processors NGP have the same frequency and the same phase.

FIG. 13 shows the vertical retraces VR illustrated as rectangular pulses of the displays D, which belong to the two network graphics processors NGP 1 and NGP 2, as a function of time t, including the numbers N−1, N, N+1 etc. of the video frames FW of a video image source S or a video insertion IS, i.e. of the video frames that can be read from the video frame queue 2 for rendering into the back buffer 6, which are written to a video frame queue 2 (ring buffer), each belonging to one network graphics processor NGP and thus being available for reading in the video frame queue 2. By double buffering and swap-locking, the vertical retraces VR of the two network graphics processors NGP 1 and NGP 2 have the same frequency (vertical display frequency f_{d}) and the same phase. Due to the above described effects, in particular different transit times via the network LAN and the decoders 3, the mutually corresponding video frames, however, do not arrive from the decoders 3 or in the video frame queues 2 at the same time, but instead with a time difference. In the example of FIG. 13, the video frames FW1 in the video frame queue 2 of the network graphics processor NGP 1 are retarded or delayed by 1.28 times the period Tₛ of the video stream frequency compared to the video frames FW2 in the video frame queue 2 of the network graphics processor NGP 2. Furthermore, the vertical display frequency f_{d} of the displays D differs from the period Tₛ of the video stream frequency fₛ. In addition, both the relative time delay of the video frames FW1 and FW2 and the video stream frequency fₛ, and possibly the vertical display frequency f_{d} of the displays D, may be subject to fluctuations. If they are not compensated, all of these effects can cause that at a specific moment of time different video frames are displayed on the two displays D of the network graphics processors NGP 1 and NGP 2, thus resulting in a tearing effect.

Because of double buffering and swap-locking, video frames only become visible on the displays D with the next vertical retrace VR, which is performed with the vertical display frequency f_{d}, after being written from the respective network graphics processor NGP to the respective back buffer 6 as a video frame FR rendered into the back buffer 6, and then become visible on the displays D as an appearing video frame FV with the next vertical retrace VR. If, as in the example in FIG. 13, fₛ<f_{d} and fₛ is not an integer multiple of f_{d}, the moments of time of the appearance of the video frames FV do not fit into the time pattern of the displays D specified by the vertical display frequency f_{d}. Without the content synchronization according to the invention, for example, the network graphics processor NGP 1 in FIG. 13 would select the video frame FW1=N+1 as video frame FR to be rendered, and would display it on the display D1 after the next vertical retrace VR with the relative Vsync counter number NSR=1 (the relative Vsync counter number is the current return count number). At the same time, the network graphics processor NGP 2 would select the video frame FW2=N−1 as video frame FR to be rendered and would display it on the display D2 after the next vertical retrace VR with the relative Vsync counter number NSR=1. This leads to frame tearing in the presentation of a moving object displayed on the displays D1 and D2 because after the vertical retrace VR with the relative Vsync counter number NSR=1, these different video frames are displayed on the displays D1 and D2. In the example in FIG. 13, the network graphics processor NGP 1 would a little later select the video frame FW1=N+8 for the display D1 for rendering, and at the same time the network graphics processor NGP 2 would select the video frame FW2=N+7 for the display D2, which would also lead to frame tearing, because after the vertical retrace VR with the relative Vsync counter number NSR=10, these different video frames are shown on the displays D1 and D2.

The frame synchronization according to the invention by means of the mediation function described below is designed in exactly such a way, that in such a situation the actual moments of time of becoming visible on the displays D is a best approximation to the ideal moments of time, and that frame tearing is avoided so that on the displays D involved in the display of the video stream of a video image source S (the displays D1 and D2 in FIG. 13) render the same video frames FR into the back buffer 6 at the same time. This purpose is served by caching via the video frame queues 2 and frame synchronization explained further below by means of a mediation function, which maps vertical retraces VR identified by a relative Vsync counter NSR to a local relative video frame counter NFR for the video frames FR to be processed, i.e. rendered, wherein both counters NSR and NFR start at zero at a common frame synchronization point of time TS. The term “map” is to be understood here in the mathematical sense, i.e. the mediation function provides a relationship between the relative Vsync counter NSR as the function argument (independent variable) and the local relative video frame counter NFR as the function value (dependent variable), which assigns a value of the local relative video frame counter NFR to each value of the relative Vsync counter NSR.

The values of the counters NSR and NFR are also shown in FIG. 13. The counter NSR for vertical retraces VR increments by one value at each vertical retrace VR, starting at the frame synchronization point of time TS. In contrast, the counter NFR for the video frames FR to be rendered does not continuously increment by one value, but instead is derived by way of a mediation function in the manner explained further below. The result of this frame synchronization, i.e. the values of the counter NFR for the video frames FR to be rendered that as a function of time t, is illustrated at the top of FIG. 13, as well as the identical video frames FR illustrated at the bottom of FIG. 13, which as a result are simultaneously rendered by both network graphics processors NGP 1 and NGP 2 and are thus displayed synchronized, i.e. without frame tearing, by the corresponding displays D1 and D2. At the time named exemplarily above in which without the frame synchronization according to the invention, the network graphics processor NGP 1 would choose the video frame FW1=N+1 as the video frame FR to be rendered, while at the same time the display D2 of the network graphics processor NGP 2 would display the video frame FW2=N−1 as the video frame FR to be rendered, NSR=1 and NFR=0, and the video frame simultaneously selected by both network processors NGP 1 and NGP 2 as the video frame FR to be rendered and thus synchronously displayed after the vertical retrace NSR=1 by both displays D1 and D2, is the video frame FR=N−1. The later time exemplified above in which without the frame synchronization according to the invention, the network graphics processor NGP 1 would select the video frame FW1=N+8 as the video frame FR to be rendered, while at the same time the display D2 of the network graphics processor NGP 2 would display the video frame FW2=N+7 as the video frame FR to be rendered, NSR=10 and NFR=8, and the video frame FR simultaneously selected by both network processors NGP 1 and NGP 2 as the video frame FR to be rendered and thus synchronously displayed after the vertical retrace NSR=10 by both displays D1 and D2 is the video frame FR=N+6.

A central idea of the present invention is to use a “universal” mediation function for all network graphics processors NGP participating in the display of a video image source S or a video insertion IS which arranges a balance between the video stream frequency fₛ and the vertical display frequency f_{d} in order to on the one hand, spread as evenly as possible over time, the occurrence of cases in which the same video frame is shown again (in the case of fₛ<f_{d}), or in which a video frame is skipped (in the case of fₛ>f_{d}), and on the other hand to ensure that, if necessary, at any given time, the same video frames are shown or skipped on all displays D showing a video image source S or a video insertion IS. This function, which is hereinafter briefly referred to as mediation function MF, maps vertical retraces VR identified by a relative Vsync counter NSR, which begins at zero at a frame synchronization point of time TS (hereinafter the variable NSR for the relative Vsync counter NSR, which counts the vertical retraces from the last frame synchronization, which sets the zero point for the counter), on video frames, that are identified by a counter that starts at zero at the same frame synchronization point of time TS (hereinafter the variable NFR for the local relative video frame counter NFR of the video frames FR to be processed, i.e. to be rendered, starting from the last frame synchronization point of time TS which sets the zero point for the counter). The mediation function MF maps the relative Vsync counter NSR to the local relative video frame counter NFR, i.e. using the mediation function MF it is locally calculated from the local relative video frame counter NFR, which video frame (identified on the basis of the absolute frame identification number id) is rendered. In other words, the mediation function MF determines from the value NSR of the relative Vsync counter NSR the video frame FR to be rendered, which is identified by the local relative video frame counter NFR.

The mediation function MF can be described in general as follows, wherein “mediation” stands for MF:

$$NFR = mediation ( NSR ) = floor ( NSR \frac{{T}_{d}}{{T}_{s}} ) = floor ( NSR \frac{{f}_{s}}{{f}_{d}} )$$

The function floor(x) provides the integer part of a real variable x, i.e. the largest integer that is ≦x. The function floor(x) is a standard library function in the C programming language and is illustrated in FIG. 16.

The local relative video frame counter NFR, i.e. the function value of the mediation function MF with the argument NSR (NFR=mediation(NSR)) then results in the greatest integer NFR for which is the product NFR×Tₛ≦NSR×T_{d}, or accordingly, as the largest integer NFR for which is the ratio NFR/fₛ≦NSR/f_{d}.

The frame synchronization process preferably comprises not only a frame start synchronization, i.e. a one-time frame synchronization which is carried out at a frame synchronization point of time TS, but also frame synchronizations performed thereafter, which are performed at later frame synchronization points of time TS, also referred to as frame resynchronization points of time. The frame start synchronization and the frame resynchronizations are carried out in the same way and are therefore both called frame synchronizations.

To start a frame synchronization of a video stream of a video image source S on multiple network graphics processors NGP, synchronization messages must be sent over the network LAN. The master network graphics processor which is defined for the video stream as the master, sends a multicast synchronization message to all network graphics processors defined as slaves which are involved in the display of the video stream, and are synchronized as prompted by the master network graphics processor.

This multicast synchronization message can also include the system time (e.g. via PTP). The system time is the local absolute time for a network graphics processor and is available there as a standard library function.

Furthermore, the synchronization message includes the frequencies f_{d} (vertical display frequency which is measured by the master network graphics processor) and fₛ (video stream frequency) as well as the absolute frame identification number of the latest video frame that was rendered last on the master network graphics processor before sending the synchronization message. This absolute frame identification number is used to determine with which video frame rendering is to begin on the network graphics processors after the frame synchronization point of time. The absolute frame identification number is embedded in the video stream. The number is necessary for synchronization, in order to identify the individual video frames in the video stream.

This synchronization message is received in the slave network graphics processors, and it is made sure that in the slave network graphics processors frame synchronization immediately begins with the transmitted values of the frequencies f_{d} and fₛ, using the mediation function MF. The implementation can hereby occur, for example, by means of the optional use of threads (also referred to as carrier type or lightweight process). During a certain time period, i.e. the mediation period, the number of vertical retraces VR (relative Vsync counter NSR with a zero point at the last frame synchronization point of time TS) is hereby continuously incremented until the mediation function is restarted at the next frame synchronization point of time, and again starts at zero. This synchronization process is hereinafter referred to as frame synchronization. Another suitable term would be correlation of video frames.

Between one frame synchronization point of time TS and a subsequent one, the local relative video frame counter is received as a function value of the mediation function MF in that it is provided with the relative Vsync counter as an argument value.

So that the count of the relative Vsync counter NSR continues correctly at the junction (the frame synchronization point of time TS), after a new start of the mediation function, one needs to start with NSR=1, depending on how you count, if NSR=0 would again provide the reference video frame id_{corr}, wherein its presentation would be repeated and the connection would not fit. The mediation function MF is to be activated only once at each junction, i.e. at the frame synchronization point of time TS at the end of a mediation period. This can also be realized with a different counting method, for example by a mediation period TM ending with NSR−1 and then continuing to count at the junction (the frame synchronization point of time TS) with NSR=0 (instead of NSR=1). Such modifications are considered to be equivalent.

In FIG. 13, the absolute reference frame identification number id_{corr} for the network graphics processor NGP 1 is the absolute frame identification number of video frame FW1=N, and for the network graphics processor NGP 2, the absolute frame identification number of video frame FW2=N−1. From these absolute reference frame identification numbers id_{corr} of the latest video frames in each video frame queue 2, the absolute frame identification number id of the video frame FR to be rendered is then determined by adding the value of the local relative video frame counter NFR in the respective network graphics processor NGP. Since the same mediation function is applied in both network graphics processors NGP, a synchronous display results, i.e. the same video frames are displayed on both network graphics processors NGP.

If in this way the video frame to be rendered into each respective back buffer 6 is selected during the time period prior to a vertical retrace VR on all network graphics processors NGP after a frame synchronization is carried out at a frame synchronization point of time TS, the same video frame with the absolute frame identification number id will simultaneously and synchronously become visible with the vertical retrace NSR on all network graphics processors NGP. In particular, the same video frames are omitted, i.e. skipped and not shown, or shown repeatedly, if this is required due to differences in the frequencies fₛ and f_{d}.

In the example of FIG. 13, which refers to the case fₛ<f_{d}, in which video frames need to be shown repeatedly, it can be seen that in regards to the video frames FR to be rendered, some video frames are repeatedly, i.e. several times, consecutively, shown on the displays, for example the video frames N−1 and N+7. With the frame synchronization according to the invention, however different and time-varying processing times and transit times of a video frame to the respective back buffers 6 of the network graphics processors NGP can be compensated in such a way, that at one time the same video frames are shown on the displays D. In FIG. 13, the same video frames FR are synchronously displayed by the displays regardless of the different and time-varying delays of video frames FW1 and FW2. The mediation function MF thus eliminates the jitter (e.g. from the encoders) or balances it. This jitter may, for example, have the consequence at a video stream frequency of 40 Hz that the actual time interval of the video frames is not a steady 40 msec, but instead between 20 msec and 70 msec, i.e. it varies by +/−50%. The mediation function MF can compensate for this. However, the mediation function itself or alone does not cause synchronization of the display of the video frame on the displays.

The process of starting or activating the frame synchronization of video frames or frame identification numbers is preferably repeated every now and then at new frame resynchronization points of time TP, for example, in periodic, i.e. regular, time intervals. The mediation function is in this case applied in sections, namely from one frame synchronization point of time to the next frame synchronization point of time (from one frame synchronization to the next, from one reset of the mediation function to the next). The transitions from one application of the mediation function to the next (at the frame synchronization points of time) might also be referred to as the junction.

The repetition of the new start of the mediation function will be referred to as frame resynchronization. Another suitable term would be recorrelation. The rate or frequency of the frame resynchronization, i.e. of the repetition of the frame synchronization, or the rate or frequency with which the synchronization messages SN are sent from the master network graphics processor Master-NGP to the slave network graphics processors Slave-NGP, i.e. with which a frame synchronization is performed at frame synchronization points of time TS, falls advantageously, for example, between 0.05 Hz and 10 Hz, preferably between 0.1 Hz and 5.0 Hz, more preferably between 0.2 Hz and 3.0 Hz, particularly preferable between 0.5 Hz and 2.0 Hz. The rate at which the frame synchronization is performed, i.e. the frequency of the frame synchronization points of time TS, and the rate with which the mediation function MF is reset and synchronized by the master network graphics processor Master-NGP, is thus considerably lower than the vertical display frequency f_{d} and may be less than 1/10, 1/20, 1/50 or 1/100 of the display frequency f_{d}, in preferred embodiments it may be about 1/50 of the video stream frequency fₛ. The rate can be adapted to the special design of the network LAN, the hardware equipment, as well as the type and frequency of one or several video image sources S. It can be fixed, or can be dynamically adjusted. The frame resynchronization proceeds in the same way as a frame start synchronization. After a frame synchronization start point of time TS, i.e. between two consecutive frame resynchronization points of time, the respective video frame to be rendered before the next vertical retraces VR by the network graphics processors NGP is selected from the video stream in the same way as after a frame synchronization, namely by using the mediation function MF.

In preferred embodiments, the mediation period TM is a fixed, predetermined value. For this purpose, for example, the mediation period TM may be determined as a fixed time period, a fixed number of vertical retrace signals Vsync, a fixed number of vertical retraces VR or a maximum value of the relative Vsync counter. Optionally, the mediation period TM can also be designed adjustable in time, for example, to dynamically adapt or adjust it in such a way that at a lowest possible frequency of synchronization messages SN, i.e. at a mediation period TM as long as possible, sufficient content synchronization is still achieved. An equivalent variant is that the mediation function MF is modified by a (differential) controller to ensure that the video frame queue 2 always has an optimal filling level of 50%. When initializing the process, the video frame queue 2 is about half-filled and the rendering is started with a mid video frame. After that, the filling level of the video frame queue 2 can be logged. During the mediation periods TM following initialization, the mediation function MF is then modified by a adjustment parameter which value depends on how much the actual filling level deviates from a desired filling level. This adjustment parameter is for example a factor that is applied to the measured ratio T_{d}/Tₛ in the argument of floor (x) of the mediation function MF. The result is, so to speak, an acceleration of the processing, i.e. an earlier display, when the filling level of the video frame queue 2 is too large (this will empty the video frame queue 2 a little more), or a later display, when the filling level of the video frame queue 2 is too small (this will fill the video frame queue 2 a little more).

FIG. 14 shows a schematic example of a mediation function MF according to the invention for the case fₛ<f_{d}, where some video frames have to be displayed multiple times. In this respect, this case corresponds to that of FIG. 13. The figure shows the vertical retraces VR with the period T_{d} of a display D as a function of time t with the relative Vsync counter NSR, which is incremented at each end VRE of the vertical retraces VR, as well as video frames FR with the period Tₛ, which are selected to be rendered and are stored in the back buffer 6, and the associated, local relative video frame counter NFR for the video frames FR to be rendered. At the frame synchronization point of time TS, both counters NSR and NFR are set to zero. Of course it is also possible to set the counters not to zero, but to a different start value. In this case, a constant value, e.g. +1 or +2, has to be added or subtracted in the appropriate equations to take into account this offset counting. Such modifications are to be considered equivalent embodiments.

The mediation function MF maps both the vertical retraces VR with NSR=0 and NSR=1 on the video frame FR with the local relative video frame counter NFR=0 to be rendered. Likewise, the vertical retraces VR with both NSR=3 and with NSR=4 are mapped on the video frame FR with NFR=2 that is to be rendered. This means that the video frames FR with the counts NFR=0 and NFR=2 are displayed twice: the video frame NFR=0 at the vertical retraces NSR=0 and NSR=1, and the video frame NFR=2 at the vertical retraces NSR=3 and NSR=4. In contrast, the vertical retraces NSR=2, NSR=5, NSR=6 and NSR=7 are mapped only once, on NFR=1, NFR=3, NFR=4 and NFR=5. This mediation function MF compensates for fₛ<f_{d}.

The following table shows a numerical example of this case fₛ<f_{d} as shown in FIG. 14 with the example values fₛ=40 Hz (Tₛ=25 ms) and f_{d}=50 Hz (T_{d}=20 ms) for 0≦NSR≦20. In this case, the video frames with NFR=0, NFR=4, NFR=8 and NFR=12 are repeated, i.e. they are again shown on a display D, as illustrated by the values marked with an exclamation point.

| NSR | $NFR = floor ( NSR \frac{{T}_{d}}{{T}_{s}} )$ |
|---|---|
| 0 | 0! |
| 1 | 0! |
| 2 | 1 |
| 3 | 2 |
| 4 | 3 |
| 5 | 4! |
| 6 | 4! |
| 7 | 5 |
| 8 | 6 |
| 9 | 7 |
| 10 | 8! |
| 11 | 8! |
| 12 | 9 |
| 13 | 10 |
| 14 | 11 |
| 15 | 12! |
| 16 | 12! |
| 17 | 13 |
| 18 | 14 |
| 19 | 15 |
| 20 | 16 |

FIG. 15 shows a schematic example of a situation corresponding to FIG. 14 for the case fₛ>f_{d}, in which video frames must be left out of the display on the displays with a corresponding mediation function MF. Hereby, the video frames NFR=4 and NFR=8 are skipped, i.e. not rendered, and as a result are not shown on the displays D, thereby compensating for the fact that fₛ>f_{d}.

The following table shows a numerical example of this case fₛ>f_{d} as shown in FIG. 15 with the example values fₛ=60 Hz (Tₛ=16.67 ms) and f_{d}=50 Hz (T_{d}=20 ms) for 0≦NSR≦20. In this case, the video frames with NFR=5, NFR=11, NFR=17 and NFR=23 are skipped, i.e. not shown on the displays, as shown by the adjacent values marked with an exclamation point.

| NSR | $NFR = floor ( NSR \frac{{T}_{d}}{{T}_{s}} )$ |
|---|---|
| 0 | 0 |
| 1 | 1 |
| 2 | 2 |
| 3 | 3 |
| 4 | 4! |
| 5 | 6! |
| 6 | 7 |
| 7 | 8 |
| 8 | 9 |
| 9 | 10! |
| 10 | 12! |
| 11 | 13 |
| 12 | 14 |
| 13 | 15 |
| 14 | 16! |
| 15 | 18! |
| 16 | 19 |
| 17 | 20 |
| 18 | 21 |
| 19 | 22! |
| 20 | 24! |

FIGS. 17 to 19 illustrate the operation of the frame synchronization according to the invention (content synchronization) between the master network graphics processor Master-NGP and a slave network graphics processor Slave-NGP, using the mediation function MF. Shown are various preparation stages, from the first initialization of the synchronization process via its gradual completion to the complete process with full synchronization. This embodiment relates to a case fₛ<f_{d}, whereat some video frames are repeated, i.e. redrawn, on the displays D, to balance the frequency difference.

The basic idea of synchronization according to the invention is that the slave network graphics processors Slave-NGP receive everything required for synchronization from the master network graphics processor Master-NGP in a synchronization message SN. This is done so that they can display the video insertions in a synchronized and tearing free manner, both at a starting time, the frame synchronization point of time TS, as well as during the period until the next synchronization message SN, or until the next frame synchronization point of time TS, independently, locally and without additional network load, i.e. during a mediation period TM, without further exchange of synchronization messages SN or synchronization information between the master network graphics processor Master-NGP and the slave network graphics processors Slave-NGP. Synchronization for a mediation period TM takes place only once, namely at the vertical retrace at the frame synchronization point of time TS that follows a synchronization message SN and belongs to the synchronization message SN. There is no immediate reaction to irregular events occurring during a mediation period TM that interfere with or disrupt the synchronization (e.g. emptying or overflowing of the video frame queue 2, a strong frequency change of the vertical display frequency f_{d} and/or of the video stream frequency fₛ, etc.), but only after the end of the current mediation period TM by initializing a new synchronization then. With irregular events, it is accepted that during the current mediation period TM, the display of the video insertion occurs unsynchronized, i.e. with tearing, and is synchronized again only after the next frame synchronization point of time TS.

In FIG. 17, a first preparatory stage of the synchronization process of the content synchronization is illustrated. It shows the initial start-up, i.e. the start after a first initialization at a frame synchronization point of time TS. Up to the first frame synchronization point of time TS, the displays of the video frames of a video insertion run completely unsynchronized on the displays. Shown are the values of the synchronized Vsync counter NS for the master network graphics processor Master-NGP defined as master, over the time t. The value of the synchronized Vsync counter NS is supplied by the so-called vertical retrace management of the network graphics processors NGP and it counts the vertical retraces VR of the displays D or the display wall 1, i.e. the vertical retrace signals Vsync of the displays D. The vertical retrace VR is carried out with the frequency of the vertical retrace signal Vsync with which the displays D are synchronized (via frame lock or gen lock), i.e. with the vertical display frequency f_{d}. The counting of the synchronized Vsync counter NS thus occurs with the display frequency f_{d}, the frequency of the vertical retrace signal Vsync, at time intervals of the period T_{d}.

The synchronized Vsync counter NS is a counter, i.e. its value increases by one, from one vertical retrace VR to the next. The value is the same on all network graphics processors NGP, i.e. the synchronized Vsync counter NS is synchronized on all network graphics processors NGP (e.g. by means of PTP and frame lock or gen lock), so that at any given time, the same absolute value for the synchronized Vsync counter NS is present on all network graphics processors NGP. Thus, in FIG. 17, the same synchronized sequence of the synchronized Vsync counter NS occurs for the slave network graphics processor Slave-NGP.

The synchronization of the network graphics processors NGP and the implementation of the synchronization comprises three layers, independent of one another, that build on each other. The lowest layer is the synchronization of the local clocks on the individual network graphics processors NGP, for example using PTP (Precision Time Protocol). This layer has no knowledge of the vertical retrace management. A second layer is the vertical retrace management that uses the synchronized clocks to program the graphics cards of the individual network processors NGP in such a way (via frame lock or gen lock) that its vertical retraces occur with the required accuracy (deviation of less than 0.5 msec) at the same time. This second layer has no knowledge of the video streams to be processed or displayed. The third layer is the so-called or actual inter-NGP-synchronization which performs the content synchronization. From the second layer, this third layer receives the synchronized Vsync counter NS supplied by the second layer via a function call. The third layer uses the synchronized Vsync counter NS instead of direct time values of the local synchronized clocks.

Furthermore, the values of the relative Vsync counters NSR are represented in FIG. 17 for the master network graphics processor Master-NGP and the slave network graphics processor Slave-NGP. These values are the relative value of the synchronized Vsync counter NS relative to the synchronized Vsync counter value at the last restart of the mediation function MF, i.e. at the last preceding frame synchronization point of time TS. The relative Vsync counter NSR is the difference between the current value of the synchronized Vsync counter NS and its value at the last frame synchronization point of time TS, i.e. a relative counter, as it counts relative to the last frame synchronization point of time. The relative Vsync counters NSR are local counters, i.e. counters on the respective network graphics processors NGP, for the vertical retraces VR, relative to the vertical retrace VR that existed at the last performed frame synchronization point of time TS. The vertical retrace VR takes place with the frequency of the vertical retrace signal Vsync with which the displays D are synchronized (via frame lock or gen lock), i.e. with the vertical display frequency f_{d}. The counting of the relative Vsync counter NSR thus occurs with the frequency of the vertical retrace signal Vsync, i.e. with the same frequency as the synchronized Vsync counter NS. By coupling the relative Vsync counters NSR with the synchronized Vsync counter NS and the frame synchronization points of time TS common for the displays D, the relative Vsync counters NSR are synchronized on all network graphics processors NGP so that at any point of time (after a first frame synchronization point of time TS), the same value for the relative Vsync counters NSR is present on all network graphics processors NGP. The relative Vsync counters NSR are used locally by the network graphics processors NGP for the continued counting in the mediation function MF starting at a frame synchronization point of time TS.

In the unsynchronized startup phase before the first frame synchronization point of time TS in FIG. 17, no values for the relative Vsync counters NSR are specified because it is not possible to do so before a first frame synchronization point of time TS, due to the absence of a reference value, i.e. a synchronized Vsync counter NS selected at frame synchronization point of time TS. At the frame synchronization point of time TS, the relative Vsync counters NSR are set to an initial value (in this case zero) and from then on, count synchronously. The synchronized value of the relative Vsync counters NSR can from then on be used as an argument in the mediation function MF of the network graphics processors NGP.

In FIG. 17, for the master network graphics processor Master-NGP and the slave network graphics processor Slave-NGP, also the absolute frame identification numbers id are specified for those video frames which are presently written into the video frame queue 2 as a decoded stream 4 by the decoder 3 of the respective network graphics processor NGP. They are processed from the video frame queue 2, i.e. read out from the video frame queue 2 as a video frame FR to be rendered for display on the display D, rendered with the renderer 5 and written to the back buffer 6 as the video frame FV that is becoming visible. The absolute frame identification numbers id of the video frames of the video stream come from the video stream itself, namely from the RTP timestamps of the encoder which encodes the respective video stream, and are embedded in the video stream. They identify the individual video frames which are embedded in the video stream and are general across the network graphics processors, i.e. are the same for a particular video frame in all network graphics processors NGP (hence referred to as an “absolute” value), and can therefore be used to identify the video frames in the video stream when synchronizing the video frames on the individual network graphics processors NGP. However, the absolute frame identification numbers id can only be used to identify the video frames and not for the purpose of “timing”, i.e. the timed control or synchronization of the display of the video frames, because of the uncertainty of the time stamps in the RTP protocol. Furthermore, the absolute frame identification number id is not a count, which, for example, is proven by the fact that it can increase its value irregularly by more than one from one video frame to the next.

The frequency of video frames 4 in the video stream from the decoder 3 which are written into the video frame queue 2 or rendered from it, corresponds on average to the video stream frequency fₛ, so that on average, the video frames follow each other in a time interval of the period Tₛ of the video stream frequency. Due to the above-mentioned effects, especially the jitter, the supply of video frames of the video stream from the decoder 3 is not temporally uniform but instead fluctuates without the synchronization according to the invention. This is illustrated in FIG. 17 by the fluctuating time interval ˜Tₛ in the absolute frame identification numbers id of the decoded video streams 4 from the decoder 3.

Due to the above-mentioned effects (different network transfer durations, different processing times of the decoders 3), the rendering of video frames FR without the synchronization according to the invention is not synchronized between the network graphics processors NGP so that in FIG. 17, both the completion times of the decoding of the video frames and the absolute frame identification numbers id of the rendered video frames FR differ between the master network graphics processor Master-NGP and the slave network graphics processor Slave-NGP. As a result, in a vertical retrace VR, i.e. at a specific synchronized Vsync counter NS, video frames with different, absolute frame identification numbers id are rendered into the respective back buffer 6 as video frames FR for the master network graphics processor Master-NGP and the slave network graphics processor Slave-NGP, resulting in the described frame tearing. The content synchronization according to the invention ensures that during all vertical retraces VR, i.e. during all vertical retrace signals Vsync and thus at all values of the synchronized Vsync counter NS, the same video frames, i.e. the video frames with the same absolute frame identification number id, are presented by the display screens D participating in the display of a video insertion, thereby avoiding the frame tearing.

This is caused by the local video frame queues 2 for the decoded video frames on the network graphics processors NGP, the local video frame counters NF (NFM on the master network graphics processor Master-NGP, NFS on the slave network graphics processors Slave-NGP), the local relative video frame counters NFR (NFRM on the master network graphics processor Master-NGP, NFRS on the slave network graphics processors Slave-NGP), the synchronization messages SN belonging to frame synchronization points of time TS which are sent to the slave network graphics processors Slave-NGP just before the frame synchronization point of time by the master network graphics processor Master-NGP, and by the mediation function MF.

The values of the local video frame counters NF (NFM on the master network graphics processor Master-NGP, NFS on the slave network graphics processors Slave-NGP) of the video frames of the video stream on the respective network graphics processors NGP are delivered by the respective decoders 3 of the network graphics processors NGP and are therefore locally available on the respective network graphics processors NGP. The local video frame counters NF count (in principle from any starting value) the video frames that are decoded on the respective network graphics processor NGP, which are stored in the video frame queues 2, and are counters, i.e. their values increase by one from video frame to video frame. However, the local video frame counters NF of the network graphics processors NGP are not synchronized for the network graphics processors NGP involved in the display of a video insertion, i.e. on each individual network graphics processor NGP, to each video frame (with a certain, absolute frame identification number id) are assigned respective, locally different values of the local video frame counters NF.

As long as no video frame is lost from the video stream during decoding of a video stream on a network graphics processor NGP, e.g. due to a malfunction, a failure, a faulty transmission or a time-dependent problem, the local video frame counter NF respectively increases by one from one video frame to the next on a network graphics processor NGP. As this applies to all local video frame counters NF, it follows that the pairwise differences of the local video frame counters NF, i.e. the difference (the “mismatch” or “offset”, hereinafter “the video frame counter difference”) between the local video frame counter NF of a network graphics processor NGP and the local video frame counter NF of another network graphics processor NGP is constant over the time as long as no video frame is lost from the video stream during the decoding of a video stream on a network graphics processor NGP, i.e. as long as the sequence of a video frames decoded by the network graphics processor NGP is not interrupted.

Consequently, the video frame counter difference DNF between the local video frame counter NFS of a slave network graphics processor Slave-NGP and the local video frame counter NFM of the master network graphics processor Master-NGP (DNF=NFS-NFM) is also constant over time as long as during decoding of a video stream, no video frame gets lost from the video stream on either of the two network graphics processors NGP. The content synchronization according to the invention makes use of this last characteristic, i.e. the temporal constancy of the video frame counter difference DNF of a local video frame counter NFS of a slave network graphics processor Slave-NGP as it relates to the local video frame counter NFM of the master network graphics processor Master-NGP, because it enables the local video frame counter NFS of the slave network graphics processor Slave-NGP to be correlated (scaled), locally on a slave network graphics processor Slave-NGP, to the local video frame counter NFM of a master network graphics processor Master-NGP. In this way, the same video frame, i.e. the video frame with the same absolute frame identification number id, can be selected on the slave network graphics processor Slave-NGP to be displayed just like the one on the master network graphics processor Master-NGP. By use of the synchronization message SN it is checked whether the video frame counter difference DNF is constant and in the event of a change, a corresponding correction is carried out in order to re-establish the synchronous display.

The absolute frame identification numbers id originating from the video stream and the respective values of the local video frame counters NF (NFM on the master network graphics processor Master-NGP, NFS on the respective slave network graphics processor Slave-NGP) belonging to the absolute frame identification numbers id are each stored in a video frame queue 2 by the network graphics processors NGP for a certain number of absolute frame identification numbers id. The video frames that are written to the video frame queues 2 by the decoders 3 thus include not only the image information per se (the decoded video frame), but also the associated absolute frame identification number id and the value of each associated local video frame counter NF for each individual video frame. This local allocation in the video frame queues 2 between the absolute frame identification number id and the respective local video frame counter NF is indicated in FIG. 17 by cross references [2] to the video frame queues 2, and is logged locally by the network graphics processors NGP.

Furthermore, in FIG. 17, the values of the local relative video frame counters NFR (NFRM on the master network graphics processor Master-NGP, NFRS on the slave network graphics processors Slave-NGP) are shown. They are each the current value of the local video frame counter NF minus the value of the local video frame counter NF_{corr} for the last reference video frame id_{corr} (the video frame with an absolute reference frame identification number id_{corr} at the last frame synchronization point of time TS), locally on the network graphics processors NGP:

NFR=NF−NF_{corr}

The local relative video frame counter NFR is also the function value of the mediation function MF at any given point (for any value of the relative Vsync counter NSR) and is used for selecting the video frame FR to be rendered, i.e. the local relative video frame counter NFR determines the video frame to be processed (to be rendered) by counting starting from the frame synchronization point of time TS, and the video frame determined by the local relative video frame counter NFR is rendered for display on the display.

Since FIG. 17 illustrates the yet completely unsynchronized initialization phase, no values for the local relative video frame counter NFRM on the master network graphics processor Master-NGP and the local relative video frame counter NFRS on the slave on the network graphics processor Slave-NGP are shown until the first frame synchronization point of time TS.

At a synchronization message point of time TSN, the master network graphics processor Master-NGP sends the slave network graphics processors Slave-NGP a synchronization message SN over the network. They are transmitted preferably in multicast mode (multicast sync messages or multicast sync telegrams), and only from the master network graphics processor Master-NGP to the slave network graphics processors Slave-NGP, but not from the slave network graphics processors Slave-NGP to the master network graphics processor Master-NGP or between the slave network graphics processors Slave-NGP. They serve to perform the content synchronization at a subsequent frame synchronization point of time TS, by which the master network graphics processor Master-NGP and the slave network graphics processors Slave-NGP are synchronized with each other, as prompted by the master network graphics processor Master-NGP.

The synchronization messages SN from the master network graphics processor Master-NGP to the slave network graphics processors Slave-NGP ensure that the mediation functions MF start at the same times with the same relative Vsync counters NSR and the same frequency ratio fₛ/f_{d} or T_{d} Tₛ on the network graphics processors NGP. So that the synchronization messages SN are present on time at the slave network graphics processors Slave-NGP and can be processed by the slave network graphics processors Slave-NGP at the same time, they are sent out shortly before the next frame synchronization point of time TS. A frame synchronization point of time TS is the point in time at which an application period of a mediation function MF ends and a new application period starts with a reset, local relative Vsync counter NSR. A frame synchronization point of time TS is therefore the junction between two mediation function sections, i.e. between two successive mediation periods TM. Because the latency of the multicast synchronization messages SN over the network is small (approximately 1 msec), it is sufficient if they are sent one or two frame periods T_{d} before the frame synchronization point of time TS.

Because of network latency, a synchronization message SN must be sent at a time lag for safety before the next frame synchronization point of time TS so that it reaches the slave network graphics Slave-NGP duly until the frame synchronization point of time TS. For this purpose, under normal operating conditions of the network, an up-front to the frame synchronization point of time TSV of less than 1 msec suffices, at peak loads in the network several milliseconds (less than 10 msec) are sufficient. In practice, one or two vertical retraces are enough, i.e. it is generally advantageous if this up-front to the frame synchronization point of time TSV falls between 1×T_{d} and 3×T_{d}. Accordingly, an advantageous feature can be that the synchronization messages SN associated with the frame synchronization points of time TS are sent by the master network graphics processor to the slave network graphics processors at synchronization message points of time TSN, which are by an up-front to the frame synchronization point of time TSV before the corresponding, following frame synchronization point of time TS, wherein the up-front to the frame synchronization point of time falls between one half and five, preferably between one and three periods T_{d}, of the vertical display frequency f_{d}, wherein a preferred value is two periods T_{d}.

A synchronization message SN of the master network graphics processor Master-NGP to the slave network graphics processors Slave-NGP contains an excerpt of information that is logged on the master network graphics processor Master-NGP locally, e.g. in the form of table values or protocols. This log does not include the entire past record, but only the information for a certain, more recent period which corresponds approximately to the range of video frame queue 2. This logged information includes the local mapping between the absolute frame identification numbers id and the local video frame counter NFM of the master network graphics processor Master-NGP of the video frames in the video frame queue 2 of the master network graphics processor Master-NGP, i.e. each entry in the video frame queue 2 of the master network graphics processor Master-NGP contains the absolute frame identification number id of the video frame and the corresponding, local video frame counter NFM.

The same information is logged accordingly in each of the slave network graphics processors Slave-NGP, during a period which is comparable to the master network graphics processor Master-NGP. Accordingly, this logged information contains the local mapping between the absolute frame identification numbers id and the local video frame counter NFS of the slave network graphics processor Slave-NGP of the video frames in the video frame queue 2 of the slave network graphics processor Slave-NGP, i.e. each entry in the video frame queue 2 of a slave network graphics processor Slave-NGP includes the absolute frame identification number id of the video frame and the associated local video frame counter NFS.

In this way, all network graphics processors NGP are aware which absolute frame identification numbers id are assigned to which local video frame counter NF for the video frames buffered in the video frame queue 2. It is thereby guaranteed that all momentary views of the video frame queues 2 for the video frames were stored at the same time (within the limits of the accuracy of the first (PTP) and the second (vertical retrace management) layer).

A synchronization message SN of the master network graphics processor Master-NGP to the slave network graphics processors Slave-NGP contains the following extract of the above-explained, logged information:
(i) A momentary view (snapshot) of the video frame queue 2 of the master network graphics processor Master-NGP at a point of time of the relative Vsync counter NSR which is preceding the next frame synchronization point of time TS by an up-front (lead time) TSV to the frame synchronization point of time. This momentary view contains the local mapping between the absolute frame identification numbers id and the local video frame counter NFM of the master network graphics processor Master-NGP of the video frames in the video frame queue 2 of the master network graphics processor Master-NGP.
(ii) The value of the local video frame counter NFM of the master network graphics processor Master-NGP for the current video frame, which was last read out by the master network graphics processor Master-NGP from the video frame queue 2 of the master network graphics processor Master-NGP for rendering, i.e. read out immediately prior to sending the synchronization message SN.
(iii) The video stream frequency fₛ (or the information of the period Tₛ of the video stream frequency fₛ equivalent thereto) measured by the master network graphics processor Master-NGP.
(iv) The vertical display frequency f_{d} (or the information of the period T_{d} of the vertical display frequency f_{d} equivalent thereto). The vertical display frequency f_{d} is measured by the master network graphics processor Master-NGP and transmitted as a consistent value to all slave network graphics processors Slave-NGP so that the mediation function on the slave network graphics processors Slave-NGP exactly matches with the master network graphics processor Master-NGP. Accordingly, with a synchronization message SN of the master network graphics processor Master-NGP to the slave network graphics processors Slave-NGP is also transmitted information regarding the vertical display frequency f_{d} (or the information of the period T_{d} of the vertical display frequency f_{d} equivalent thereto) that is measured by the master network graphics processor Master-NGP. Said information either includes the vertical display frequency f_{d} itself or the ratio with the video stream frequency fₛ (or the information on the ratio of the period of the vertical display frequency and the period of the video stream frequency equivalent thereto).
(v) Instead of the information in accordance with (iii), (video stream frequency fₛ or period Tₛ of the video stream frequency fₛ) and (iv) (vertical display frequency f_{d} or period T_{d} of the vertical display frequency f_{d}), the synchronization message SN may in modified embodiments contain only the ratio of these quantities, i.e. the ratio fₛ f_{d} or T_{d}/Tₛ since only the ratio of these quantities is entered in the mediation function and thus only the value of this ratio, but not the frequencies themselves, are needed on the slave network graphics processors Slave-NGP. Such modifications are considered to be equivalent.

Up until the first sending of a synchronization message SN or until the termination of the stepwise initialization of the synchronization, not all of this information is yet stored on the master network graphics processor Master-NGP or the slave network graphics processors Slave-NGP, or not all the information included in a complete synchronization message SN. Until the first frame synchronization point of time TS, which is shown in FIG. 17, the display of the video frames on the displays D takes place entirely unsynchronized. From the first frame synchronization point of time TS, the master network graphics processor Master-NGP and the slave network graphics processors Slave-NGP are synchronized in regards to the points of time at which the mediation function MF is restarted, i.e. the points of time at which the relative Vsync counter NSR restarts from zero. These points of time are the frame synchronization points of time TS and each restart takes place at the same values of the synchronized Vsync counter NS. In this way, a synchronous basic clock is achieved because from the frame synchronization point of time TS, the relative Vsync counter NSR is synchronized between the master network graphics processor Master-NGP and the slave network graphics processors Slave-NGP. However, the local relative video frame counters NFR and the video frames shown on the displays D are not yet synchronized.

FIG. 18 shows the sequence of the next preparation stage, namely the values of FIG. 17 at the time just before and after the second frame synchronization point of time TS, which follows the first synchronization point of time TS after a mediation period TM. In the example shown, the mediation period TM is thirty times as large as the period T_{d} of the vertical display frequency f_{d}, i.e. TM=30×T_{d}. Again a synchronization message SN is sent to the slave network graphics processors Slave-NGP from the master network graphics processor Master-NGP at a time which by the up-front to the frame synchronization point of time TSV before the synchronization point of time TS. This synchronization message already includes the frequencies fₛ and f_{d} (or the frequency ratio fₛ/f_{d}), and since the relative Vsync counter NSR was already synchronized at the first frame synchronization point of time, the mediation functions MF are synchronized between the master network graphics processor Master-NGP and the slave network graphics processors Slave-NGP starting at the second frame synchronization point of time TS, as all values for the argument of the mediation function MF are synchronized.

Thus, from the second frame synchronization point of time TS, the master network graphics processor Master-NGP and the slave network graphics processors Slave-NGP are synchronized also with regard to the “phase”, and the function value of the mediation function MF determines which of the video frames is rendered locally on a network graphics processor NGP from the local video frame queue 2 of the respective network graphics processor NGP. However, a complete synchronization does not yet exist because the content synchronization is still missing, so that the video frames are not only displayed with the same cycle by the network graphics processors NGP, but also consistent and thus tearing free the same video frames (with the same absolute frame identification number id) are displayed. Therefore, after the second frame synchronization point of time TS, the video frames FR rendered into the back buffer 6 generally still differ between the master network graphics processor Master-NGP and the slave network graphics processor Slave-NGP or slave network graphics processors Slave-NGP.

For the full synchronization, a local additive value, the frame offset, must still be determined locally by the slave network graphics processors Slave-NGP after the second frame synchronization point of time TS which indicates by how many video frames the display of video frames on the slave network graphics processor Slave-NGP (the video frames FR rendered on the slave network graphics processor Slave-NGP) as compared to the display of the video frames on the master network graphics processor Master-NGP (the video frames FR rendered on the master network graphics processor Master-NGP) was offset immediately before the frame synchronization point of time TS (specifically, prior to the synchronization message SN). It is then assumed that this frame offset is constant during the mediation period TM, following a frame synchronization point of time TS, and the display of the video frames is corrected accordingly during that period by additively including the frame offset, so as to achieve a full synchronization then. With each frame synchronization point of time TS, this frame offset is newly determined or verified, so that any changes in this regard are corrected.

This determination of the frame offset between the video frames rendered by the master network graphics processor Master-NGP and one slave network graphics processor Slave-NGP each, is carried out by use of the synchronization message SN that is transmitted immediately before the third frame synchronization point of time TS shown in FIG. 19. FIG. 19 thus illustrates the synchronization process because from the third frame synchronization point of time TS, a complete synchronization is achieved.

At every start of a new section of the mediation function MF, i.e. at the start of a new mediation period TM, after a reset of the mediation function MF to a relative Vsync counter NSR of zero at a frame synchronization point of time TS, by use of a synchronization message SN transmitted immediately prior thereto, momentary views of the respective video frame queue 2 are stored on all network graphics processors NGP, i.e. on the master network graphics processor Master-NGP and all slave network graphics processors Slave-NGP which are involved in the display of the video insertion that is shown. To be precise, the momentary views are stored at the beginning of the same vertical retraces, which are identified by the synchronized Vsync counter NS, which is supplied by the vertical retrace management on all participating network graphics processors NGP. Each entry in the video frame queue 2, and therefore also in the momentary views, contains the absolute frame identification number id of the video frame and the associated, local video frame counter NF. With the next synchronization message SN, which the master network graphics processor Master-NGP sends over the network to the slave network graphics processors Slave-NGP in multicast mode by the up-front to the frame synchronization TSV, which in the illustrated example is two vertical retraces before the next vertical retrace and hence two vertical retraces before the next reset of the mediation function, prior to the frame synchronization point of time TS, all slave network graphics processors Slave-NGP receive, in good time and before this next frame synchronization point of time TS, the current momentary view of the video frame queue 2 of the master network graphics processor Master-NGP and can compare it to their own momentary view that was stored at the same time as that of the master network graphics processor Master-NGP.

To determine the frame offset, the momentary view of the video frame queue 2 of the master network graphics processor Master-NGP received with the synchronization message SN is compared locally in the slave network graphics processor Slave-NGP to a locally stored momentary view of the video frame queue 2 of the slave network graphics processor Slave-NGP. The entries in the video frame queue 2 are thereby compared. These have an overlap in the absolute frame identification numbers id, i.e. some absolute frame identification numbers id exist both in the momentary view of the video frame queue 2 of the master network graphics processor Master-NGP as well as in the momentary view of the video frame queue 2 of the slave network graphics processor Slave-NGP.

From these, an absolute frame identification number id is taken, which is included in each of both momentary views, and with its help, the slave network graphics processor Slave-NGP locally determines the frame offset (the difference between the local relative video frame counters NFR). This information can then be used to re-scale the local relative video frame counter NFRS of the slave network graphics processor Slave-NGP to the system of the master network graphics processor Master-NGP. It is thus possible to calculate or work only with the local video frame counters NFRS on the slave network graphics processors Slave-NGP in order to determine the video frame FR to be rendered and to perform the synchronization because the slave network graphics processors Slave-NGP are scaled, i.e. based on and adjusted, to the system of the master network graphics processor Master-NGP.

In principle, when comparing the synchronization message SN on a slave network graphics processor Slave-NGP with the values stored on the slave network graphics processor Slave-NGP, one can search for an arbitrary, younger absolute frame identification number id, which is included in both momentary views, i.e. in the momentary view of the video frame queue 2 of the master network graphics processor Master-NGP which was transmitted with the synchronization message SN to the slave network graphics processor Slave-NGP, and in the momentary view of the video frame queue 2 of slave network graphics processor Slave-NGP, in order to determine the frame offset based on this video frame. In advantageous embodiments in which the synchronization message SN optionally includes the absolute frame identification number id of the latest video frame on the master network graphics processor Master-NGP, the absolute frame identification number id of the latest video frame is transmitted in a synchronization message SN from the master network graphics processor Master-NGP to the slave network graphics processors Slave-NGP to check whether there is an overlap for this particular, latest video frame. Accordingly, an advantageous embodiment is that a synchronization message SN of the master network graphics processor Master-NGP to the slave network graphics processors Slave-NGP also includes the absolute frame identification number id of the latest video frame on the master network graphics processor Master-NGP, i.e. the video frame that was last rendered on the master network graphics processor Master-NGP, and that when comparing the momentary views, it is checked whether this absolute frame identification number id is contained in the compared momentary views. In the case of overlapping of the momentary views (whether for any of the video frames, or for the latest video frame) there are two possibilities. Either the last, absolute frame identification number id of the master network graphics processor Master-NGP falls in the momentary view of the video frame queue 2 of the slave network graphics processor Slave-NGP, or the last, absolute frame identification number id of the slave network graphics processor Slave-NGP falls in the momentary view of the video frame queue 2 of the master network graphics processor Master-NGP.

If there is no overlap between the two compared momentary views, i.e. there is no video frame with the same absolute frame identification number id that both momentary views have in common, then the offset in the video frame display between slave network graphics processor Slave-NGP and master network graphics processor Master-NGP is so great that at the selected maximum number of entries in the video frame queue 2, a synchronization in the display of the video frames between these network graphics processors NGP cannot be achieved. One can then attempt to enable a synchronization by extending the video frame queues 2. This, however, increases the number of buffered video frames and also the delay with which the video is displayed, so that there are limitations if a display is to take place with a short delay.

If after the second frame synchronization point of time TS the display of video frames on the slave network graphics processor Slave-NGP were already synchronized with the master network graphics processor Master-NGP, the slave network graphics processor Slave-NGP would find that the content of its video frame queue 2, i.e. of its momentary view, looks exactly like the momentary view of the video frame queue 2 of the master network graphics processor Master-NGP sent via synchronization message by the master network graphics processor Master-NGP, and the content synchronization would not need to intervene to regulate. Generally, though, one will notice after the completed initialization after the second frame synchronization point of time TS, by means of the absolute frame identification numbers id, that there is a mutual displacement of the contents displayed, i.e. that a frame offset is present, and the purpose of the content synchronization is to eliminate or correct this. For this purpose, it must first be determined by how many video frames the video frame contents of the video frame queues 2 are “offset” from one another. However, the absolute frame identification numbers id cannot be directly used for this, since their values do not postulate any other information other than uniquely identifying the video frames. A distance between two video frames, i.e. the number of video frames placed between two video frames, could be determined only very unreliably with only the values of the absolute frame identification numbers id.

However, the local video frame counters NF are suitable for determining the distance between two video frames (on the same network graphics processor NGP) through a simple subtraction, always assuming that on the way from the encoder over the network and the decoder with its (software) decoding, no video frame is lost, because the local video frame counters NF are generated only after the decoding on each network graphics processor NGP. Thus, in contrast to the absolute frame identification number id, they do not come from the video stream. The latter, however, is precisely the reason why a distance between two video frames cannot simply be calculated also as the difference of their local video frame counters NF across network graphics processor boundaries; with identical video frames a zero difference should arise, but this will generally not be the case since the local video frame counters NF are generated independent of each other on each network graphics processor NGP. This generally non-zero video frame counter difference DNF of the local video frame counters NF between two network graphics processors NGP for a video frame is, however, independent of the selected video frame for which the difference is being considered. This video frame counter difference DNF is exactly the constant by which the local video frame counters NF on the two network graphics processors NGP considered for comparison differ due to their different starting points or starting times (always under the aforementioned condition that no video frame has been lost). With this (constant) video frame counter difference DNF hence for a preset, local video frame counter NFS on a slave network graphics processor Slave-NGP, the corresponding local video frame counter NFM of the same video frame (identified by its absolute frame identification number id) can be specified on the master network graphics processor Master-NGP, or vice versa.

This video frame counter difference DNF of the local video frame counter NFS of a slave network graphics processor Slave-NGP compared to the local video frame counter NFM of the master network graphics processor Master-NGP, is independent of the operation of the synchronization process and is determined by calculating the difference DNF of the local video frame counters NF between slave network graphics processor Slave-NGP and master network graphics processor Master-NGP with any video frame that is included in both the current momentary view of the slave network graphics processor Slave-NGP and in the momentary view of the master network graphics processor Master-NGP taken at the same time, i.e. last received by the master network graphics processor Master-NGP via a synchronization message SN.

This serves to determine during synchronization by how many video frames the slave network graphics processor Slave-NGP needs to correct its current extraction of video frames from its video frame queue 2 for further processing, i.e. for the rendering for display on the display of the display wall, forward or backward (referred to the pointer which reads out the respective video frame), so that its display is synchronous to that of the master network graphics processor Master-NGP. For this purpose, the slave network graphics processor Slave-NGP calculates the video frame counter difference DNF of the video frames which the master network graphics processor Master-NGP and the slave Network graphics processor Slave-NGP have taken from their video frame queue at the time that the last synchronization message SN (here the synchronization message SN before the frame synchronization point of time TS in FIG. 19) is sent, at the, or up to the, next frame synchronization point of time TS (here the third frame synchronization point of time TS in FIG. 19). So that the slave network graphics processor Slave-NGP can determine this video frame counter difference DNF, the master network graphics processor Master-NGP also sends with the synchronization message SN its local video frame counter NFM for the current, i.e. most recent, video frame which it processed at the most recent, preceding time of the frame synchronization message SN (here the frame synchronization message SN immediately prior to the third frame synchronization point of time TS in FIG. 19). With the determination of this frame offset, the “re-scaling” of the local video frame counter NFS of the slave network graphics processor Slave-NGP to the local video frame counter NFM of the master network graphics processor Master-NGP can then take place according to the abovementioned method, so that a difference of zero means that the same video frame is present. With the thus determined number of video frames of the respective offset between slave network graphics processor Slave-NGP and master network graphics processor Master-NGP, the withdrawal of video frames from the video frame queues on the slave network graphics processors Slave-NGP is now corrected by delaying or advancing, thus synchronizing the display of the video frames.

The factual alignment (the content synchronization) of the video frames that are rendered on the network graphics processors NGP, whereat it is ensured that for all synchronized Vsync counters NS of the displays D, the same video frames are displayed, thus takes place using table values/protocols in the form of momentary views that are sent with the synchronization messages SN from the master network graphics processor Master-NGP to the slave network graphics processors Slave-NGP. The momentary view of the master network graphics processor Master-NGP with the data regarding which absolute frame identification number id on the master network graphics processor Master-NGP belongs to which local video frame counter NFM, is sent each with a synchronization message SN from the master network graphics processor Master-NGP to the slave network graphics processors Slave-NGP. On the slave network graphics processors Slave-NGP, each time a local comparison process takes place by which this momentary view of the master network graphics processor Master-NGP is compared to the corresponding, local momentary view of the respective slave network graphics processor Slave-NGP. In the process, it is checked whether there is an overlap for a certain absolute frame identification number id, for example, the most recent, absolute frame identification number of the master network graphics processor Master-NGP. If thereby absolute frame identification numbers id are included multiple times, i.e. were displayed several times, in a momentary view (of the master network graphics processor Master-NGP or the slave network graphics processor Slave-NGP), the first occurring value is used. Using the absolute frame identification numbers id which are general across the network graphics processor, the local video frame counters NFM of the master network graphics processor Master-NGP are each matched with the local video frame counters NFS of the slave network graphics processor Slave-NGP. Through this comparison of the momentary views, on each slave network graphics processor Slave-NGP the information on the number of video frames is obtained, by which the display of the video frames on the respective slave network graphics processor Slave-NGP was offset, i.e. preceded or lagged behind, as compared to the master network graphics processor Master-NGP. At the next start of the mediation function, i.e. at the next frame synchronization point of time TS, these respective offsets can then be added or subtracted as a correction value to the respective local relative video frame counter NFSR of the slave network graphics processors Slave-NGP. As a result, from then on, all slave network graphics processors Slave-NGP display the same video frames synchronously with the master network graphics processor Master-NGP.

From the third frame synchronization point of time TS shown in FIG. 19, a complete synchronization of the display of the video insertion on the displays is thus achieved. From then on, the synchronization continues to run in the same manner as after the second frame synchronization point of time TS. At the frame synchronization points of time TS, the slave network graphics processors Slave-NGP check whether the content synchronization is still achieved or whether it has occurred in the meantime and thus needs to be corrected. For this purpose, the slave network graphics processors Slave-NGP again check which video frame was processed (rendered) by the master network graphics processor Master-NGP at the transmission time of the immediately preceding synchronization message, and by each comparing the momentary view received in the synchronization message SN from the master network graphics processor Master-NGP to their stored momentary views, determine which video frame with which absolute frame identification number id was processed by the respective slave network graphics processor Slave-NGP at the same time as the master network graphics processor Master-NGP. From these, an absolute frame identification number id is derived, which is included in each of both momentary views, and the slave network graphics processors Slave-NGP check the frame offset (the difference of the local video frame counters NF between the slave network graphics processors Slave-NGP and the master network graphics processor Master-NGP) locally with their help to see if it has remained the same as compared to the previous mediation period. In general, the content synchronization will still be met. If the frame offset has changed, this is corrected by correspondingly adjusting the correction value from the frame synchronization point of time.

To continue the mediation function after the synchronization message SN from a frame synchronization point of time TS (in this example, two vertical retraces after the synchronization message SN), the slave network graphics processors Slave-NGP determine by how many video frames they are each offset from the master network graphics processor Master-NGP, and accordingly rescale their local relative video frame counters NFRS to the local relative video frame counter NFRM of the master network graphics processor Master-NGP, using the determined video frame counter difference of the local video frame counters between the master network graphics processor Master-NGP and the slave network graphics processor Slave NGP. For example, if the slave network graphics processor Slave-NGP notices that with its display it is ahead or lagging behind the display of the video insertion on the master network graphics processor Master-NGP by two video frames, this difference or time offset is corrected or compensated in that the slave network graphics processor Slave-NGP adds this offset with a counter sign in the function value of the mediation function during calculation of the selected video frame.

The vertical frequency f_{d} of the displays D and the frame rate fₛ for each video stream determine the function values of the mediation function MF for this video stream. Since the frequencies fₛ and f_{d} can change slightly over time, they (or their ratio) are, according to an advantageous embodiment, determined not only once, but the measurement of one or both quantities is repeated every now and then, on a regular basis, or at intervals, for example, in periodic, i.e. regular, time intervals, preferably in the cycle of the vertical display frequency f_{d}. The determination of these frequencies fₛ and f_{d} (by the master network graphics processor Master-NGP) or their ratio is further preferably carried out by averaging over a plurality of periods so that the values used for the frequencies fₛ and f_{d} in the synchronization process according to the invention, or the value of their ratio, are averaged frequency values. The averaging can be carried out in accordance with a preferred embodiment via a temporal sliding measurement window having the time length tₘ, for example, in time with the vertical display frequency f_{d}. Averaging is done over several periods that are situated between a start and an end value, wherein tₘ is the measurement duration time, i.e. the time length of the measurement window. According to an advantageous feature, it is therefore proposed that the determination of either the video stream frequency fₛ, or of the period Tₛ of the video stream frequency fₛ equivalent thereto, and of the vertical display frequency f_{d}, or of the period T_{d} of the vertical display frequency f_{d} equivalent thereto, or of the ratio fₛ/f_{d} of the video stream frequency fₛ with the vertical display frequency f_{d}, or of the inverse f_{d}/fₛ equivalent thereto, or of the ratio T_{d}/Tₛ of the period T_{d} of the vertical display frequency f_{d} with period Tₛ of the video stream frequency fₛ, or of its inverse Tₛ/T_{d} equivalent thereto, is repeated now and then, periodically, intermittently, or preferably with a sliding measurement window M, in the cycle of the vertical display frequency f_{d}.

FIG. 20 illustrates the measurement of the vertical display frequency f_{d} and the video stream frequency fₛ by the network graphics processor NGP, which serves as the master. The relative Vsync counter NSR at the ends VRE of the vertical retraces VR and the local relative video frame counter NFRM for the video frames FW to be rendered, which are available in the video frame queue 2, are shown as a function of time t. Thereby, NSRₛₜₐᵣₜ and NFRMₛₜₐᵣₜ are initial values and NSR_{end} and NFRM_{end} are end values in the current measurement window M of the time length tₘ. Also shown is a next measurement window Mₙₑₓₜ. The current values of the frequencies f_{d} and fₛ are then obtained as follows from the averaging over the current measurement window M:

$${f}_{d} = \frac{{NSR}_{end} - {NSR}_{start}}{{t}_{m}}$$

$${f}_{s} = \frac{{NFRM}_{end} - {NFRM}_{start}}{{t}_{m}}$$

Accordingly, for determining the display frequency f_{d}, the master network graphics processor can also use the synchronized Vsync counter NS instead of the relative Vsync counter NSR, or for determining the video stream frequency fₛ, it can use the local video frame counter NFM instead of the local relative video frame counter NFRM. In order to obtain a good averaging, the number of periods over which averaging is done, i.e. the number of vertical retraces VR included in the averaging, should be greater than what is shown in the illustration in FIG. 20. Advantageously, the number of vertical retraces VR for which averaging is done falls between 50 and 200, preferably around 100. It can be predetermined or dynamically adapted. It may, for example, be advantageous to start with a smaller measurement window M so that during the initialization of the display or during a synchronization, initially gross values for the frequencies fₛ and f_{d} can be available. During the course of operation, the length tₘ of the measuring window M can then be extended, for example, by increasing the window size from one measurement to another, until the selected, final value is reached.

According to another advantageous embodiment, the master network graphics processor Master-NGP can trigger an early frame synchronization, independent of the base rate with which the frame synchronization is performed, as soon as the interval-like or continuous measurement of the frequencies fₛ and f_{d} reveals that the ratio fₛ/f_{d} or T_{d}/Tₛ has changed by more than one limit value of, for example, 0.01, as compared to an initial value.

### LIST OF REFERENCE NUMBERS

1 display wall
2 video frame queue
3 decoder
4 decoded video frame
5 renderer
6 back buffer
D display
D1 display 1
Dn display n
DNF video frame counter difference NFS-NFM
DVI Digital Visual Interface
E Ethernet
EC encoder
EC1 encoder 1
ECm encoder m
FR video frame rendered into back buffer
FV video frame becoming visible
FW video frame in the video frame queue
f_{d} vertical display frequency
fₛ video stream frequency
GbE gigabit Ethernet
IS video insertion
id absolute frame identification number
id_{corr} absolute frame identification number of a reference video frame
LAN network
M measurement window
Mₙₑₓₜ next measurement window
m number of video image sources
MF mediation function
n number of displays of the display wall
NF local video frame counter
NFM local video frame counter Master-NGP
NFS local video frame counter Slave-NGP
NFR local relative video frame counter (counter for video frame to be rendered)
NFRM local relative video frame counter Master-NGP
NFRS local relative video frame counter Slave-NGP
NFR_{end} final value of NFR
NFRₛₜₐᵣₜ starting value of NFR
NGP network graphics processor
NGP 1 network graphics processor 1
NGP n network graphics processor n
NS synchronized Vsync counter
NSR relative Vsync counter
NSR_{end} final value of NSR
NSRₛₜₐᵣₜ starting value of NSR
S video image source
S1 video image source 1
Sm video image source m
SN synchronization message
SW switches
SS synchronization signal generator
T_{d} period of the vertical display frequency
TS frame synchronization point of time
TSN synchronization message point of time
TSV up-front to the frame synchronization point of time
Tₛ period of video stream frequency
t time
TM mediation period
tₘ length of measurement window
VR vertical retrace
VRE end of vertical retrace
Vsync vertical retrace signal

1-15. (canceled)

16. A computer-implemented method for synchronizing the display of video frames from a video stream with a video stream frequency of a video insertion of a video image source, which is simultaneously displayed on two or more displays of a display wall composed of a plurality of displays, wherein
the displays are each controlled by an associated network graphics processor which includes a computer with a network card and a graphics card, and are operated with the same vertical display frequency,
the local clocks are synchronized on the network graphics processors,
the vertical retraces of the graphics cards of the network graphics processors that drive the displays are synchronized by means of frame lock or gen lock, and
the video stream is transmitted from the video image source over a network to the network graphics processors,
comprising the following steps:
the network graphics processors participating in the display of a video image source are organized in a master-slave architecture, wherein one network graphics processor is configured as a master network graphics processor for the video image source, and the other network graphics processors are configured as slave network graphics processors, wherein for each video image source the respective allocation of roles is arranged such that for synchronizing the display of the video image source, the master network graphics processor sends synchronization messages to the slave network graphics processors, which are received and evaluated by the slave network graphics processors,
the video frames are each identified by means of an absolute frame identification number that is embedded in the video stream,
the display of the video frames is synchronized among the network graphics processors at frame synchronization points of time, which are each followed by a mediation period, which extends over a plurality of vertical retraces of the display wall and lasts until the next frame synchronization point of time, wherein shortly before a frame synchronization point of time, i.e. before the start of a mediation period, a synchronization message is sent from the master network graphics processor to the slave network graphics processors at a synchronization message point of time, and wherein during the mediation period, video frames are displayed synchronously by the network graphics processors in that the network graphics processors each locally determine the video frame to be displayed by means of a mediation function, which is common to the network graphics processors, and wherein parameters which are included in the argument of the mediation function and are required for synchronously displaying the video frames, are transmitted in the synchronization message,
wherein these parameters either include the video stream frequency measured by the master network graphics processor, or the equivalent period of the video stream frequency measured by the master network graphics processor and the vertical display frequency measured by the master network graphics processor, or the equivalent period of the vertical display frequency measured by the master network graphics processor, or said parameters include the ratio of the video stream frequency measured by the master network graphics processor with the vertical display frequency measured by the master network graphics processor, or its equivalent reciprocal value, or these parameters include the ratio of the period of the vertical display frequency measured by the master network graphics processor with the period of the video stream frequency measured by the master network graphics processor, or its equivalent reciprocal value,
the master network graphics processor synchronizes the mediation function by sending synchronization messages at a rate that is lower than the vertical display frequency,
the video frames of the video stream that are to be rendered are each locally counted by the network graphics processors by means of local video frame counters, and are each buffered by hooking into a respective video frame queue, including their associated absolute frame identification number and the associated local video frame counter, so that each video frame queue contains the local mapping between the absolute frame identification numbers and the local video frame counter,
with the synchronization message of the master network graphics processor to the slave network graphics processors, a momentary view of the video frame queue of the master network graphics processor is transmitted at the synchronization message point of time, which is by an up-front to the frame synchronization point of time before the next frame synchronization point of time, wherein the momentary view contains the local mapping between the absolute frame identification numbers and the local video frame counter of the master network graphics processor for the video frames in the video frame queue of the master network graphics processor,
in order to detect a local frame offset that specifies the number of video frames by which the display of video frames on the respective slave network graphics processor is offset relative to the display of the video frames on the master network graphics processor prior to the synchronization message, the momentary view of the video frame queue of the master network graphics processor, which is received with the synchronization message by the slave network graphics processors, is locally compared to a locally stored momentary view of the video frame queue of the slave network graphics processor and from this comparison, the frame offset is determined,
and the local frame offset is corrected on the slave network graphics processors starting with the frame synchronization point of time, in that starting with the frame synchronization point of time on the slave network graphics processors, the frame offset is added to the local video frame counter of the slave network graphics processor, which specifies which video frame is to be rendered,
so that the slave network graphics processors receive from the master network graphics processor everything that they require to synchronize in the synchronization message, in order to be able to autonomously display the video frames of the video insertion locally in a synchronized manner with the master network graphics processor, both at the frame synchronization point of time as well as during the subsequent mediation period up to the following frame synchronization point of time.

17. The method according to claim 16, wherein the local clocks are synchronized on the network graphics processors by PTP.

18. The method according to claim 16, wherein when the video stream is transmitted from the video image source over a network to the network graphics processors, the video image source is respectively encoded and compressed by means of an encoder prior to transmission over the network, and after receipt is decoded by the network graphics processors by means of a decoder.

19. The method according to claim 16, wherein the absolute frame identification number is derived from the RTP timestamps of the video frames.

20. The method according to claim 16, wherein the display of the video frames by the network graphics processors is performed multi-buffered and swap-locked.

21. The method according to claim 20, wherein the display of the video frames by the network graphics processors is performed double buffered and swap-locked.

22. The method according to claim 16, further comprising the following steps:
the vertical retraces of the graphics cards of the network graphics processors are counted locally by the network graphics processors by means of a Vsync counter that is synchronized among the network graphics processors,
by the network graphics processors, local relative Vsync counters are formed which represent the difference between the current, synchronized Vsync counter and its value at the last frame synchronization point of time,
the network graphics processors use the relative Vsync counters (NSR) as the argument value of the mediation function, wherein the following applies for the mediation function:
$$NFR = MF ( NSR ) = mediation ( NSR ) = floor ( NSR \frac{{f}_{s}}{{f}_{d}} ) = floor ( NSR \frac{{T}_{d}}{{T}_{s}} )$$
and the mediation function calculates a local relative video frame counter as a function value, which is the difference between the local video frame counter of the video frame to be selected from the video frame queue for rendering, and the local video frame counter of the video frame at the last frame synchronization point of time, so that the video frame to be rendered for display on the display by the respective network graphics processors is determined and selected for rendering by the network graphics processors by use of the local relative video frame counter,
wherein due to the ratio of the video stream frequency divided by the vertical display frequency (or the reciprocal ratio of period durations) that is contained in the argument value of the mediation function, the mediation function balances and mediates between these two frequencies during the processing of the video frames, if these frequencies are different.

23. The method according to claim 16, further comprising the following steps:
in order to determine the frame offset, the absolute frame identification numbers contained in the momentary views are used in the comparison of the momentary view of the video frame queue of the master network graphics processor received with the synchronization message with a locally stored momentary view of the video frame queue of the slave network graphics processor, to check whether a common reference video frame is contained in the two momentary views, and for this reference video frame by the local allocation between the absolute frame identification numbers and the local video frame counters that is contained in the momentary views, a video frame counter difference is formed, which is the difference between the local video frame counter of the slave network graphics processor of the reference video frame, and the local video frame counter of the master network graphics processor of the reference video frame,
and by means of the video frame counter difference, the frame offset is determined in that first, the slave network graphics processor forms a conversion difference for the reference video frame, which is the difference between its local video frame counter and the video frame counter difference,
and by subtracting the conversion difference from the local video frame counter of the slave network graphics processor, the slave network graphics processor calculates the local video frame counter of the master network graphics processor for the video frame which was selected by the master for rendering at the synchronization message point of time,
and the frame offset is calculated as the difference between the local video frame counter of the master network graphics processor for the video frame that was selected for rendering by the slave network graphics processor at the synchronization message point of time, and the local video frame counter of the master network graphics processor for the video frame that was selected for rendering by the master network graphics processor at the same synchronization message point of time.

24. The method according to claim 16, wherein when comparing the momentary views in order to determine the video frame counter difference, one checks whether the video frame which was put last to the video frame queue of the slave network graphics processor by the slave network graphics processor, i.e. immediately prior to the sending of the synchronization message, is included in the momentary view of the master network graphics processor.

25. The method according to claim 16, wherein for determining the video frame counter difference, the value of the local video frame counter of the master network graphics processor for the video frame put last to the video frame queue of the master network graphics processor by the master network graphics processor, i.e. immediately prior to sending the synchronization message, and the absolute frame identification number of this video frame are transmitted with the synchronization message of the master network graphics processor to the slave network graphics processor, and that when comparing the momentary views, one checks whether this video frame is included in both momentary views that are compared.

26. The method according to claim 16, wherein the sending of a synchronization message and the synchronization of the display of video frames at frame resynchronization points of time is repeated.

27. The method according to claim 26, wherein the sending of a synchronization message and the synchronization of the display of video frames at frame resynchronization points of time is repeated in periodic, i.e. regular, time intervals.

28. The method according to claim 16, wherein the rate or frequency with which the synchronization messages are sent from the master network graphics processor to the slave network graphics processors, i.e. with which a frame synchronization is performed at frame synchronization points of time, falls between 0.05 Hz and 10 Hz.

29. The method according to claim 28, wherein the rate or frequency with which the synchronization messages are sent from the master network graphics processor to the slave network graphics processors, i.e. with which a frame synchronization is performed at frame synchronization points of time, falls between 0.1 Hz and 5.0 Hz.

30. The method according to claim 28, wherein the rate or frequency with which the synchronization messages are sent from the master network graphics processor to the slave network graphics processors, i.e. with which a frame synchronization is performed at frame synchronization points of time, falls between 0.2 Hz and 3.0 Hz.

31. The method according to claim 28, wherein the rate or frequency with which the synchronization messages are sent from the master network graphics processor to the slave network graphics processors, i.e. with which a frame synchronization is performed at frame synchronization points of time, falls between 0.5 Hz and 2.0 Hz.

32. The method according to claim 16, wherein the mediation period is a fixed, predetermined value.

33. The method according to claim 32, wherein the mediation period is selected from the group consisting of a fixed time period, a fixed number of vertical retrace signals, a fixed number of vertical retraces and a maximum value of the relative Vsync counter.

34. The method according to claim 16, wherein the synchronization messages associated with the frame synchronization points of time are sent by the master network graphics processor to the slave network graphics processors at synchronization message points of time, which are by an up-front to the frame synchronization point of time before the corresponding, following frame synchronization point of time. The frame synchronization point of time, wherein the up-front to the frame synchronization point of time falls between one half and five periods of the vertical display frequency.

35. The method according to claim 19, wherein the up-front to the frame synchronization point of time falls between one and four periods of the vertical display frequency.

36. The method according to claim 34, wherein the up-front to the frame synchronization point of time falls between one and three periods of the vertical display frequency.

37. The method according to claim 16, wherein the synchronization messages are sent as multicast messages by the master network graphics processor to the slave network graphics processors.

38. The method according to claim 16, wherein the determination of either the video stream frequency, or of the period of the video stream frequency equivalent thereto, and of the vertical display frequency, or of the period of the vertical display frequency equivalent thereto, or of the ratio of the video stream frequency with the vertical display frequency or of the inverse equivalent thereto, or of the ratio of the period of the vertical display frequency with period of the video stream frequency, or of its inverse equivalent thereto, is repeated with the repetition selected from the group consisting of now and then, periodically, intermittently, and with a sliding measurement window, in the cycle of the vertical display frequency.

39. A computer program product, in particular a computer-readable, digital data carrier with stored, computer-readable, computer-executable instructions for performing a method according to claim 16, i.e. with instructions that, when loaded into a processor, a computer or a computer network and executed, cause the processor, the computer or the computer network to carry out the process steps and operations in accordance with claim 16.

40. A computer system comprising a plurality of network graphics processors, each of which has a computer with a network card, a graphics card and a network interface, and a video synchronization module for performing a method according to claim 16.

41. A display wall which is composed of a plurality of displays and is used for displaying one or more video streams from one or more video image sources, wherein it comprises a computer system according to claim 40.
